(19) United States
(12) Patent Application Publication
(10) Pub. No.: US 2017/0102232 A1
(43) Pub. Date: Apr. 13, 2017

(54) METHOD AND APPARATUSES FOR PROJECTING SCALED IMAGES

(71) Applicant: Daniel Roman Prochoda, Woodland Park, CO (US)

(72) Inventor: Daniel Roman Prochoda, Woodland Park, CO (US)

(21) Appl. No.: 15/385,827

(22) Filed: Dec. 20, 2016

Related U.S. Application Data
(63) Continuation-in-part of application No. 14/931,874, filed on Nov. 4, 2015.
Application No. 14/931,874 is a continuation-in-part of application No. 14/882,465, filed on Oct. 14, 2015.
Application No. 14/882,465 is a continuation-in-part of application No. 14/874,465, filed on Oct. 4, 2015.
Application No. 14/874,465 is a continuation-in-part of application No. 14/874,465, filed on Oct. 4, 2015.
(60) Provisional application No. 62/289,291, filed on Jan. 31, 2016.
(60) Provisional application No. 62/270,021, filed on Dec. 20, 2015.

(51) Int. Cl. G01C 3/08; G01B 11/25

(52) U.S. Cl. CPC G01C 3/08; G01B 11/25

(57) ABSTRACT

Methods and apparatuses for projecting scaled images to a surface is disclosed. The methods and apparatuses include measuring distances to various points of the surface and altering the image based on an approximation of the surface based on the measured distances to the various points such that the altered image is substantially accurately scaled when projected back onto the surface. For a sufficiently flat surface, the image may be altered by scaling based on the measured distances and angles to the various points. For a curved surface, the image may be altered by scaling based on the approximation of the surface. The projected image may include a substantially accurate measurement markers when projected onto the surface for measurement directly on the surface.

### CROSS REFERENCE TO RELATED APPLICATIONS

The present application is a Continuation-in-Part (CIP) of U.S. patent application Ser. No. 14/931,874, filed Nov. 4, 2015; the present application is a CIP of U.S. patent application Ser. No. 14/882,465, filed Oct. 14, 2015, which is a CIP of U.S. patent application Ser. No. 14/874,465, filed Oct. 4, 2015; the present application is a CIP of U.S. patent application Ser. No. 14/874,465, filed Oct. 4, 2015; the present application claims the benefits of and priority, under 35 U.S.C. §119(e), to U.S. Provisional Patent Application No. 62/289,291, filed Jan. 31, 2016, and U.S. Provisional Patent Application No. 62/270,021, filed Dec. 20, 2015; each of the above-identified applications being fully incorporated herein by reference.

### RELATED FIELD OF THE INVENTION

The present application relates generally to methods and apparatuses for projecting scaled images and specifically for projecting images including distant measurement markings onto a flat, curved, and/or irregular surface and to scaling the projected images to account for distortions including scaling issues caused by surface orientation and/or surface contour.

### BACKGROUND

Visualizing distances on flat, curved, and/or irregular surfaces in related art typically involves placing a ruler, tape measure, and/or other object of a known distance on the surface to establish length along the surface. However, this task in the related art is complicated by a number of issues.

One deficiency in the related art is that the curvature of the surface affects how the true distance of the curve can be effectively measured. For example, a tape measure may be able to follow the curve of a surface if the curvature is in one direction (e.g., a curve in the x-plane only), but may not be able to effectively follow the curve of a surface if the curvature is in multiple directions (e.g., a curve in the x-y plane).

Another deficiency in the related art is that a surface having a long distance may require more than one person to effectively perform the measurement (e.g., the need to have an assistant hold one end of the measuring device).

Yet another deficiency in the related art is that attempting to measure a surface that is in difficult to access locations may be difficult.

Further deficiency in the related art is that a measurement device may need to be moved to measure multiple locations, therefore costing time and energy.

### SUMMARY

Accordingly, there is a need for methods and apparatuses for projecting scaled images to address the above deficiencies and other problems.

The present disclosure provides a method to project distance markings and/or a projected images onto surfaces while maintaining a desired scale and/or correction for distortion. This may be accomplished by using known, calculated, and/or measured values of the surface and its relation to the projection source so that the distance measurement markings and/or the image can be scaled to account for the distortion caused by surface orientation and/or contour.

Additionally, the disclosure provides a distance marking device that can be used to project distance measurement markings onto surfaces while maintaining the desired scale distances between measurement markings.

Finally, the disclosure provides a device that can be used to project an image onto a surface while maintaining the desired scale by creating a mapping of how the image needs to be corrected in order to account for distortion caused by surface orientation and/or contour.

One advantage of embodiments of the present invention is to allow a simplification of the process of measuring distances by projecting distance markings onto target surfaces of the measurement.

Another advantage of embodiments of the present invention is to increase the safety of users performing a measurement by allowing users to project measurements onto difficult to reach surfaces from a safe location to obtain measurements.

Yet another advantage of embodiments of the present invention is to allow for the measurement device to be moved to different locations while continually updating its measurement projections to maintain the desired scale.

Further advantage of embodiments of the present invention is that the method and correction needed to project distance measurements onto surfaces utilizes a closely related method that is needed to create a mapping to correct projected images that are projected onto surfaces that are distorted by the orientation of the projector to the surface, and/or by the contour of the surface; therefore embodiments of the present invention also provides a way for these projected images to be corrected.

Additional advantage of embodiments of the present invention is to provide a device for projecting an image onto a flat and/or curved surface. Images are able to be projected onto flat and/or curved surfaces without the stretching and compression that occurs when a projector is not perpendicular to a surface, and/or in which the surface contour distorts the image. Further, the surface mappings can be continually updated, thereby providing a means for moving the projected images onto different surfaces while maintaining aspect ratio.

The above and other needs are addressed by embodiments of the present invention by providing methods and apparatuses for projecting images including distant measurement markings onto a flat, curved, and/or irregular surface and to scaling the projected images to account for distortions including scaling issues caused by surface orientation and/or surface contour.

In an embodiment, an apparatus for projecting an image to a surface includes computational equipment, including a processor, configured to determine one or more portions of an altered image, the altered image being a representation of the image and each of the portions of the altered image for projection on a corresponding portion of the surface. Each of the portions of the altered image is based on a respective portion of the image and a distance to the corresponding portion of the surface and an orientation the corresponding portion of the surface. The apparatus further includes one or more projectors, each of the projectors configured to project one or more projections, each of the projections projecting at least one of the portions of the altered image to the corresponding portion of the surface. A combination of the projections of the projectors on the surface comprises at least a substantially accurate representation of the image.

In another embodiment, a method for projecting an image to a surface includes receiving one or more distances, each of the distances to a corresponding portion of the surface, and determining one or more portions of an altered image, each of the portions of the altered image based on a respective portion of the image and one of the distance to a corresponding one portion of the surface and an orientation the corresponding portion of the surface, the altered image being a representation of the image, and each of the portions of the altered image for projection on a corresponding portion of the surface. The method further includes projecting one or more projections to one or more corresponding portions of the surface, each of the projections having at least one of the portions of the altered image to the corresponding portion of the surface. A combination of the projections on the surface comprises at least a substantially accurate representation of the image.

In yet another embodiment, an apparatus for projecting an image to a surface includes one or more distance measurer configured to measure one or more distances to one or more respective portions of the surface, and computational equipment, including a processor, configured to determine one or more portions of an altered image, the altered image being a representation of the image, and each of the portions of the altered image for projection on a corresponding portion of the surface. Each of the portions of the altered image is based on a respective portion of the image and one of the distances to the one respective portion of the surface related to the corresponding portion of the surface and an orientation of the corresponding portion of the surface. The apparatus further includes one or more projectors, each of the projectors configured to project one or more projections, and each of the projections projecting at least one of the portions of the altered image to the corresponding portion of the surface. A combination of the projections of the projectors on the surface comprises at least a substantially accurate representation of the image. The altered image includes at least a first portion of the altered image and a second portion of the altered image. The first portion of the altered image corresponds to a first corresponding portion of the surface and the second portion of the altered image corresponds to a second corresponding portion of the surface. The first corresponding portion of the surface is different from the second corresponding portion of the surface in at least one point. The first portion of the altered image and the second portion of the altered image are determined based on a first distance to the first corresponding portion of the surface and a second distance to the second corresponding portion of the surface and a first orientation of the first corresponding portion of the surface and a second orientation of a second corresponding portion of the surface.

The phrases “at least one,” “one or more,” and “and/or” refer to open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module,” refers to any known or later developed hardware, software, firmware, artificial intelligence, fuzzy logic, or combination of hardware and software that is capable of performing the functionality associated with that element.

The terms “determine,” “calculate,” and “compute,” and variations thereof are used interchangeably and include any type of methodology, process, mathematical operation or technique.

It shall be understood that the term “means” shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Embodiments herein presented are not exhaustive, and further embodiments may be now known or later derived by one skilled in the art.

Functional units described in this specification and figures may be labeled as modules, or outputs in order to more particularly emphasize their structural features. A module and/or output may be implemented as hardware, e.g., comprising circuits, gate arrays, off-the-shelf semiconductors such as logic chips, transistors, or other discrete components. They may be fabricated with Very-large-scale integration (VLSI) techniques. A module and/or output may also be implemented in programmable hardware such as field programmable gate arrays, programmable array logic, programmable logic devices or the like. Modules may also be implemented in software for execution by various types of processors. In addition, the modules may be implemented as a combination of hardware and software in one embodiment.

An identified module of programmable or executable code may, for instance, include one or more physical or logical blocks of computer instructions that may, for instance, be organized as an object, procedure, or function. Components of a module need not necessarily be physically located together but may include disparate instructions stored in different locations which, when joined logically together, include the module and achieve the stated function for the module. The different locations may be performed on a network, device, server, and combinations of one or more of the same. A module and/or a program of executable code may be a single instruction, or many instructions, and may even be distributed over several different code segments, among different programs, and across several memory devices. Similarly, data or input for the execution of such modules may be identified and illustrated herein as being an encoding of the modules, or being within modules, and may be embodied in any suitable form and organized within any suitable type of data structure.

In one embodiment, the system, components and/or modules discussed herein may include one or more of the following: a server or other computing system including a processor for processing digital data, memory coupled to the processor for storing digital data, an input digitizer coupled to the processor for inputting digital data, an application program stored in one or more machine data memories and accessible by the processor for directing processing of digital data by the processor, a display device coupled to the processor and memory for displaying information derived from digital data processed by the processor, and a plurality of databases or data management systems.

In one embodiment, functional block components, screen shots, user interaction descriptions, optional selections, various processing steps, and the like are implemented with the system. It should be appreciated that such descriptions may be realized by any number of hardware and/or software components configured to perform the functions described. Accordingly, to implement such descriptions, various integrated circuit components, e.g., memory elements, processing elements, logic elements, look-up tables, input-output devices, displays and the like may be used, which may carry out a variety of functions under the control of one or more microprocessors or other control devices.

In one embodiment, software elements may be implemented with any programming, scripting language, and/or software development environment, e.g., Fortran, C, C++, C#, COBOL, Apache Tomcat, Spring Roo, Web Logic, Web Sphere, assembler, PERL, Visual Basic, SQL, SQL Stored Procedures, AJAX, extensible markup language (XML), Flex, Flash, Java, .Net and the like. Moreover, the various functionality in the embodiments may be implemented with any combination of data structures, objects, processes, routines or other programming elements.

In one embodiment, any number of conventional techniques for data transmission, signaling, data processing, network control, and the like as one skilled in the art will understand may be used. Further, detection or prevention of security issues using various techniques known in the art, e.g., encryption, may also be used in embodiments of the invention. Additionally, many of the functional units and/or modules, e.g., shown in the figures, may be described as being “in communication” with other functional units and/or modules. Being “in communication” refers to any manner and/or way in which functional units and/or modules, such as, but not limited to, input/output devices, computers, laptop computers, PDAs, mobile devices, smart phones, modules, and other types of hardware and/or software may be in communication with each other. Some non-limiting examples include communicating, sending and/or receiving data via a network, a wireless network, software, instructions, circuitry, phone lines, Internet lines, fiber optic lines, satellite signals, electric signals, electrical and magnetic fields and/or pulses, and/or the like and combinations of the same.

By way of example, communication among the users, subscribers and/or server in accordance with embodiments of the invention may be accomplished through any suitable communication channels, such as, for example, a telephone network, an extranet, an intranet, the Internet, cloud based communication, point of interaction devices (point of sale device, personal digital assistant, cellular phone, kiosk, and the like), online communications, off-line communications, wireless communications, RF communications, cellular communications, Wi-Fi communications, transponder communications, local area network (LAN) communications, wide area network (WAN) communications, networked or linked devices and/or the like. Moreover, although embodiments of the invention may be implemented with TCP/IP communications protocols, other techniques of communication may also be implemented using IEEE protocols, IPX, Appletalk, IP-6, NetBIOS, OSI or any number of existing or future protocols. Specific information related to the protocols, standards, and application software utilized in connection with the Internet is generally known to those skilled in the art and, as such, need not be detailed herein.

In embodiments of the invention, the system provides and/or receives a communication or notification via the communication system to or from an end user. The communication is typically sent over a network, e.g., a communication network. The network may utilize one or more of a plurality of wireless communication standards, protocols or wireless interfaces (including LTE, CDMA, WCDMA, TDMA, UMTS, GSM, GPRS, OFDMA, WiMAX, FLO TV, Mobile DTV, WLAN, and Bluetooth technologies), and may be provided across multiple wireless network service providers. The system may be used with any mobile communication device service (e.g., texting, voice calls, games, videos, Internet access, online books, etc.), SMS, MIMS, email, mobile, land phone, tablet, smartphone, television, vibrotactile glove, voice carry over, video phone, pager, relay service, teletypewriter, and/or GPS and combinations of the same.

### BRIEF DESCRIPTION OF THE DRAWINGS

FIG. 1 illustrates a diagram of an exemplary distance marking device according to an embodiment;

FIG. 2 illustrates a diagram for showing an exemplary non-contact method to project one or more distance markings and/or images that are to a desired scale or near to a desired scale onto a flat and/or curved surface according to an embodiment;

FIG. 3 illustrates a diagram for showing an exemplary non-contact method to project one or more distance markings and/or images that are to a desired scale or near to a desired scale onto a flat and/or curved surface using a coordinate system according to an embodiment;

FIG. 4 illustrates a diagram for showing an exemplary mathematical process for projecting one or more distance markings and/or images that are to a desired scale or near to a desired scale onto a curved surface according to an embodiment;

FIG. 5 illustrates a diagram of an exemplary distance marking device and/or projection device which can be utilized to account for distance according to an embodiment;

FIG. 6 illustrates a diagram of an exemplary distance marking device and/or projection device which can be utilized to account for distance and orientation angle according to an embodiment;

FIG. 7 illustrates a diagram of an exemplary distance marking device and/or projection device used on curved surfaces according to an embodiment;

FIG. 8 illustrates a diagram for showing an exemplary arrangement of distance measuring element beams that strike a surface that might be utilized to capture surface orientation in three dimensions according to an embodiment;

FIG. 9 illustrates a diagram of an exemplary projection device which is projecting a non-corrected image onto a curved surface according to an embodiment;

FIG. 10 illustrates a diagram of an exemplary projection device which is projecting a corrected image onto a curved surface according to an embodiment;

FIG. 11 illustrates a diagram of an exemplary distance marking device and/or projection device in which the distance measurement beams are being utilized to measure distances to the surface according to an embodiment;

FIG. 12 illustrates a diagram for showing exemplary mathematics for calculating projection angles to a surface that is perpendicular to where the measurements/projection is made according to an embodiment;

FIG. 13 illustrates a diagram for showing exemplary mathematics for calculating projection angles to a surface that is not perpendicular to where the measurements/projection is made according to an embodiment;

FIG. 14 illustrates a diagram for showing sufficiency of obtaining angles in measurement calculations;

FIG. 15 illustrate a diagram for showing a method/apparatus that might be used when measurements to more than one flat surface is made according to an embodiment;

FIG. 16 illustrates a diagram of exemplary projector and distance measurement devices that simplifies the mathematics of determining the angle of projection according to an embodiment;

FIG. 17 illustrates a diagram of an exemplary device in which the projection unit is separate from the measurement unit according to an embodiment;

FIG. 18 illustrates a diagram of an exemplary device in which the distance measuring devices are not in a triangular orientation according to an embodiment;

FIG. 19 illustrates a diagram of an exemplary device in which more than one projection unit is used, and in which the distance measuring devices are separate and not in a particular orientation according to an embodiment;

FIG. 20 illustrates a diagram of an exemplary device in which a projection unit, but no distance measuring unit is used according to an embodiment;

FIG. 21 illustrates a diagram of an exemplary device in which the device might be used with a tool such as a table saw according to an embodiment;

FIG. 22 illustrates a diagram of an exemplary device that projects distance measurements in more than one unit and with additional numeric projections to show quantity according to an embodiment;

FIG. 23 illustrates a diagram of an exemplary device with various components according to an embodiment;

FIG. 24 illustrates a diagram of an exemplary device that can adjust its projection width in a wide angle mode according to an embodiment;

FIG. 25 illustrates a diagram of an exemplary device that can adjust its projection width in a narrow angle mode according to an embodiment;

FIG. 26 illustrates a diagram of an exemplary device that can adjust the direction of its projection and/or its start location, with its projection centered, according to an embodiment;

FIG. 27 illustrates a diagram of an exemplary device that can adjust the direction of its projection and/or its start location, with its projection moved right, according to an embodiment;

FIG. 28 illustrates a diagram for showing how distance measurement markings may start in different locations according to an embodiment;

FIG. 29 illustrates a diagram of an exemplary device that projects distance measurement markings in more than one direction according to an embodiment;

FIG. 30 illustrates a diagram for showing how projection angle can affect how projected points are skewed according to an embodiment;

FIG. 31 illustrates a diagram for showing how distance measurement might be taken individually and/or in a scanning manner according to an embodiment;

FIG. 32 illustrates a diagram for showing mathematics to calculate projection angles to a curved surface according to an embodiment;

FIG. 33 illustrates a diagram for showing the mathematics to calculate projection angles to a curved surface according to an embodiment;

FIG. 34 illustrates a diagram showing how a device might be used for a rough surface according to an embodiment;

FIG. 35 illustrates a diagram showing an exemplary device that utilizes a contact measurement device according to an embodiment;

FIG. 36 illustrates a diagram showing an exemplary device utilizing a display and non-contact distance measuring devices according to an embodiment;

FIG. 37 illustrates a diagram showing how a potential mistake that might occur, and one possible solution to avoid this pitfall according to an embodiment;

FIG. 38 illustrates a diagram showing an exemplary device suitable for use near edges of surfaces according to an embodiment;

FIG. 39 illustrates a diagram showing how two different measurements might be portrayed, in this case, distance along the curve according to an embodiment;

FIG. 40 illustrates a diagram showing how two different measurements might be portrayed, in this case, distance along an axis according to an embodiment;

FIG. 41 illustrates a diagram showing how more than one projection source may form an image according to an embodiment;

FIG. 42 illustrates a diagram showing how several projection sources may each project a portion of the entire image according to an embodiment;

FIG. 43 illustrates a diagram showing how a single projection source may project an image according to an embodiment;

FIG. 44 illustrates a diagram showing another potential exemplary method of projection wherein a single image is projected according to an embodiment; and

FIG. 45 illustrates a diagram of an exemplary device to measure irregular surfaces by utilizing a scanning technique according to an embodiment.

FIG. 46 illustrates a diagram of an exemplary device to measure irregular surfaces by utilizing a scanning technique with a straight line estimation according to an embodiment.

FIG. 47 illustrates a diagram of an exemplary device to measure irregular surfaces by utilizing a scanning technique with a local curve estimation according to an embodiment.

### DETAILED DESCRIPTION

In an embodiment, methods and devices disclosed herein provide for a user to project distance measurement markings and/or images onto a surface while maintaining a desired scale of the image and/or distance markings. These may be accomplished by using information gathered about the surface orientation and contour with respect to the projection source(s) location to compensate for distortion and/or scale.

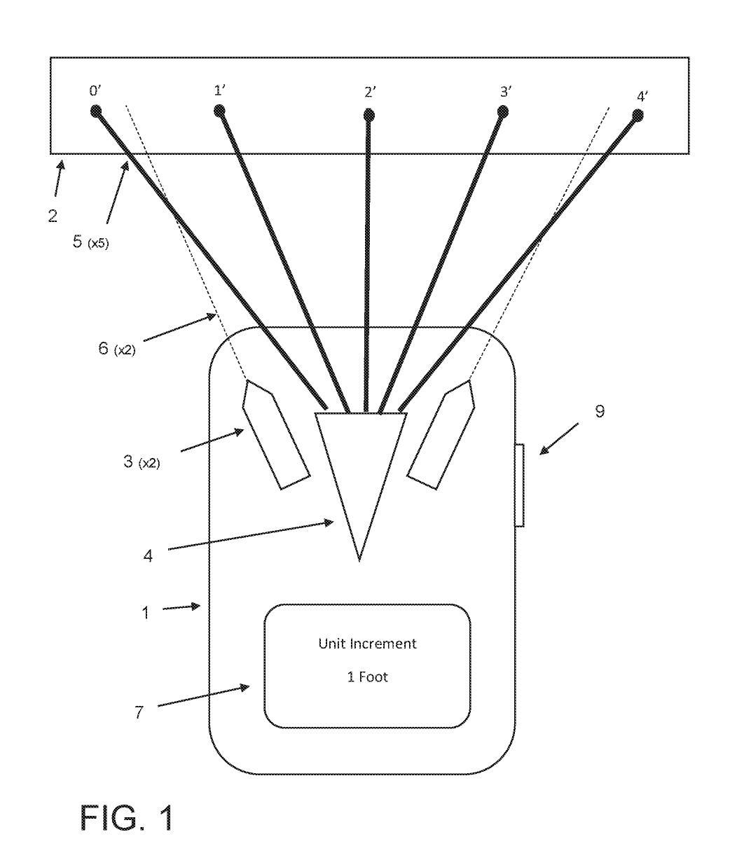

FIG. 1 illustrates a diagram of an exemplary distance marking device according to an embodiment. The distance marking device (1) is shown with two distance measuring elements (3) that are measuring the distance (6) to a flat surface (2). Once the distance measurements (6) have been obtained, the distance marking device (1) utilizes the distance measurements to compute a representation that describes the surface (e.g., numerically, symbolically, e.g., through mathematical expressions, other data representations, and/or other representations as now known or may be later derived to describe the surface), and/or directly calculates angular data that can be used by the projector (4) and/or internal processing system (not shown) to aim the distance markings beams (5) at their respective locations which are to scale when projected onto the surface. FIG. 1 shows an interface (9) which is a display that shows the desired measurement scale is 1 foot, which equates to the spacing of the distance marking beams (5).

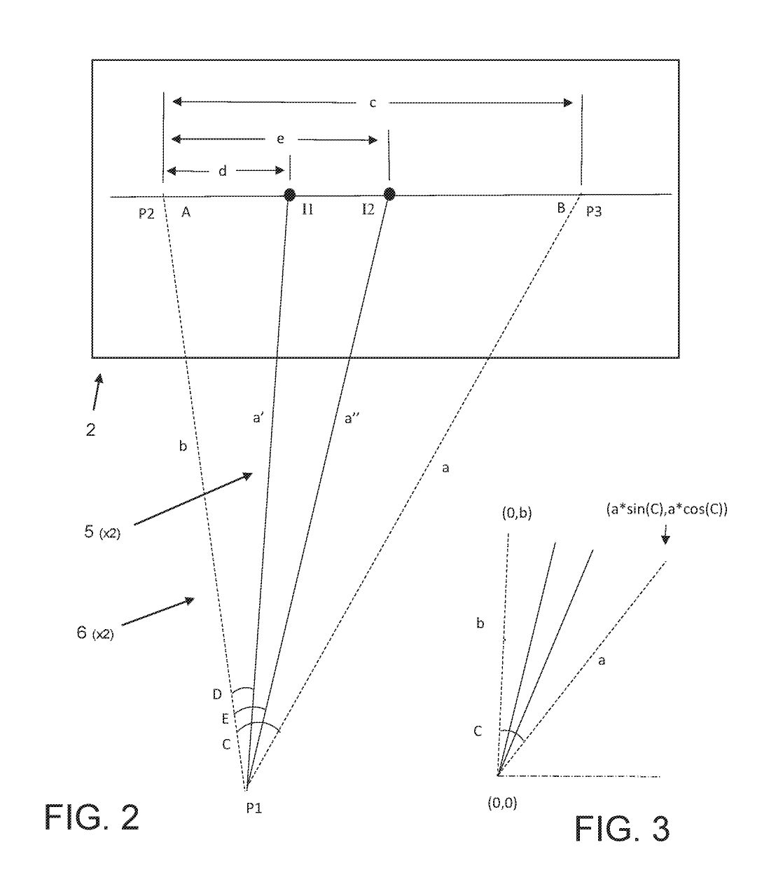

FIG. 2 illustrates a diagram for showing an exemplary non-contact method to project one or more distance markings and/or images that are to a desired scale or near to a desired scale onto a flat and/or curved surface according to an embodiment (and may create a mathematical representation of a flat surface). Two distance measuring beams (6) take distance measurements to the flat surface (2) from P1 to P2, and from P1 to P3. A line is shown on the surface that includes both the points P2 and P3, however this line is present to represent that the distance measurements should be taken as close as practical to this line to accurately reflect the surface orientation on which distance markings will be made. The angle between the two measurement beams C at P1 may be assumed to be known in this case by the angle between the two distance measuring elements.

In an embodiment, one method to determine the angle at which the projector should cast its first measurement beam utilizes trigonometry. In FIG. 2, distance of vectors are portrayed with small letters, while angles are portrayed with capital letters. With distance a and b, and angle C known, the distance c can be calculated using the Law of Cosines. Utilizing the Law of Sines, angle A can now be calculated. To calculate the position of the first projection which strikes the surface at position I1, the angle D needs to be determined as a reference point. If this method was being utilized for the distance marking device, a predetermined location from which to start the distance measurements may have already been established, wherein options might include the location on the surface which is perpendicular to the positioning of the distance marking device, and/or one of the locations at which the distance marking device measures distance to the surface such as at P2 or P3. From this location, a known distance, which may be set by the user, would then be incremented for each measurement mark. If, however, the method was being utilized to calculate surface properties for an image projection device, then a set angle D and/or a known distance d might be utilized to determine where the first ray must strike the surface. In this example, we may assume d is predetermined, in which case a new triangle is formed by P1, P2, and I1. With these two lengths and angle A known, distance a′ can now be solved using the Law of Cosines, and angle D can be determined using the Law of Sines. The process is then repeated to determine angle E, since the distance d is known, and the distance e has been determined like distance d. In this manner, the angles at P1 can be calculated to create numerous distance markings on the flat surface that follow a scaled length, and/or a mapping can be created and used that describes how the distance on the surface and/or angles at P1 change along the surface.

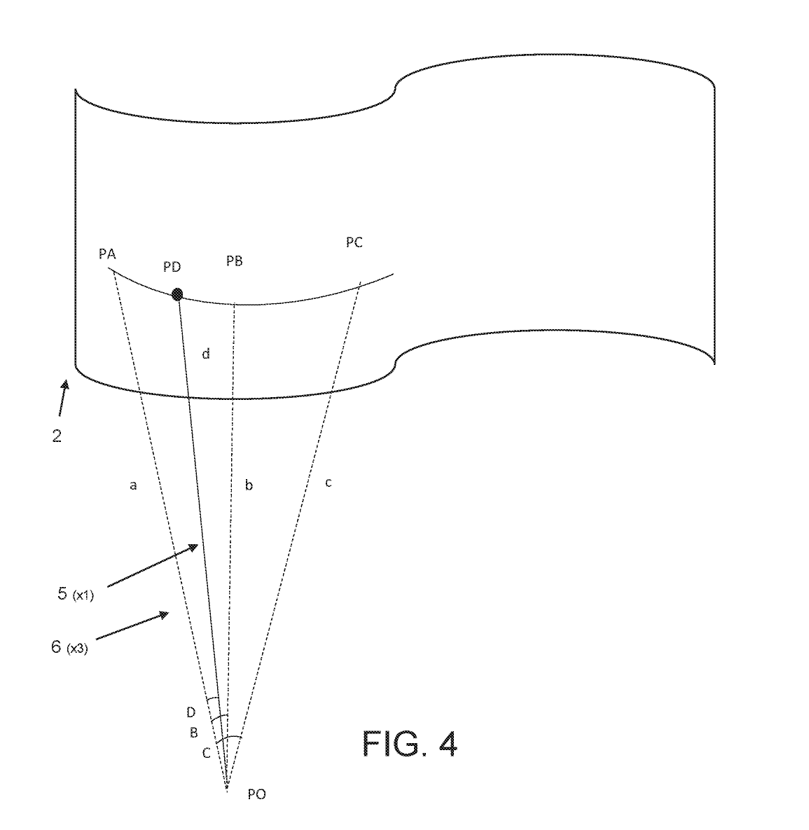

FIG. 3 illustrates a diagram for showing an exemplary non-contact method to project one or more distance markings and/or images that are to a desired scale or near to a desired scale onto a flat and/or curved surface using a coordinate system according to an embodiment. In an embodiment, an additional method to create a numerical representation of the surface utilizes the image of FIG. 3. The smaller image of FIG. 3 is a shrunken version of the larger image of FIG. 4, however rotated slightly to the right. Using the same distance measurements a, b, and known angle C, a grid system can be determined to describe the surface. In this case, the out of surface location is given the coordinates (0,0), and the distance left distance measurement is given the coordinate (0,b), since b is the measurement distance. This process has created the first axis of a coordinate system. If the other coordinate axis is then created by representing a perpendicular axis that goes to the right from point (0,0), then established trigonometric identities can be used to determine the coordinates of the right measurements point at the surface. Utilizing trigonometric expressions and/or by developing an equation for a line between the two points that strike the surface, the coordinates of the two projected measurement marks can then be determined. Using distance formulas and/or additional trigonometric expressions, a coordinate mapping can then be obtained for the length along the surface. With coordinates, projection angles and other data can also be determined as needed. Additionally, repeating the process at different locations on the surface can serve to establish a mapping of the surface that can be used for image correction.

FIG. 4 illustrates a diagram for showing an exemplary mathematical process for projecting one or more distance markings and/or images that are to a desired scale or near to a desired scale onto a curved surface according to an embodiment. FIG. 4 illustrates an arc on a curved surface (2) for which it is desired to determine coordinates and/or locate out of surface angles that represent distances along the curved surface. In an embodiment, one method to approach this problem is to create a coordinate system as was done for FIG. 3. In this case, the surface is not flat and therefore may be approximated with a Nth degree polynomial, where N is a whole number of one or higher. In this case, the surface appears to be curved in only one direction, and the curve in the area of measurements appears that it can be approximated with a second order polynomial. A second order polynomial can be generated to describe the curve if three coordinates can be obtained along the curve. Therefore, in this case at least three distance measurements (6) may be obtained for the surface. To create coordinates for these measurements, in an embodiment, a similar type of coordinate system may be used as was illustrated in FIG. 3. This provides a means to obtain the coordinates for the three distance measurements. These coordinates are then used to generate a polynomial of the second degree that represents the surface contour. With this polynomial, and a known distance from PA to PD, coordinates for PD can be obtained by parameterizing the polynomial, creating an integration expression for determining distance along the polynomial, and numerically solving the polynomial for the desired distance to determine the coordinates of point PD. With PA, PD, and PB known, trigonometric expressions can now be derived to determine the off surface angle D to determine the direction of projection (5).

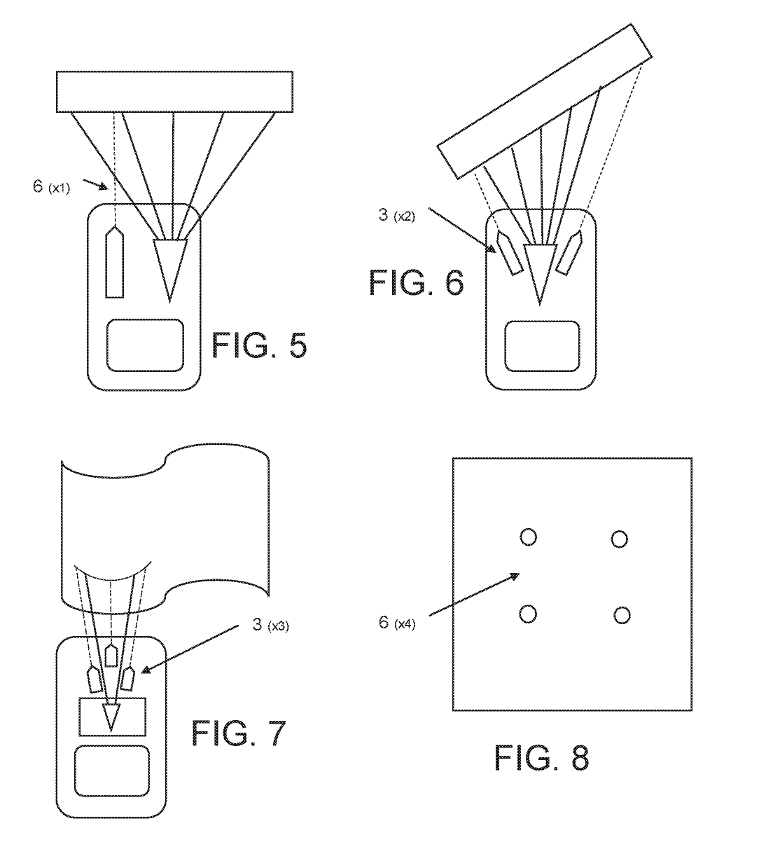

FIG. 5 illustrates a diagram of an exemplary distance marking device and/or projection device which can be utilized to account for distance according to an embodiment. The projection device and/or distance marking device may utilize only one distance measurement (6). This device may only need to account for distance from a flat surface, and may operate under the presumption that the projector is perpendicular to the surface.

FIG. 6 illustrates a diagram of an exemplary distance marking device and/or projection device which can be utilized to account for distance and orientation angle according to an embodiment. The projection device and/or distance marking device may utilize two distance measuring elements (3). This device would be able to account for distance from a flat surface, and orientation to the surface.

FIG. 7 illustrates a diagram of an exemplary distance marking device and/or projection device used on curved surfaces according to an embodiment. The projection device and/or distance marking device may utilize three distance measuring elements (3). Although the three elements appear to be equally spaced in angle, this is not a necessary condition of the measurement device. Here, the device may be capable of accounting for distance and orientation to both flat and curved surfaces, and to also account for surface contours wherein the surface can be approximated with a second order polynomial.

FIG. 8 illustrates a diagram for showing an exemplary arrangement of distance measuring element beams that strike a surface that might be utilized to capture surface orientation in three dimensions according to an embodiment. A potential pattern is made by a projection device and/or distance marking devices having four distance measurement beams (6) striking the surface. The additional distance measurement beams may provide a means for the device to obtain orientation information of a flat surface that would account for not only side to side orientation differences, but orientation differences involving the orientation from top to bottom as well.

These examples of patterns are presented for further explanation to help conceptualize how additional measurements can be utilized to capture data about different types of surfaces, but are not intended to reflect the only possible options. For instance, some distances may already be known and therefore do not require a distance measurement, or perhaps an angle to the surface is known instead of a distance. In other cases, a device may have to be calibrated to a given distance or angle, and/or a mechanical method of measurement might be utilized instead of a non-contact device.

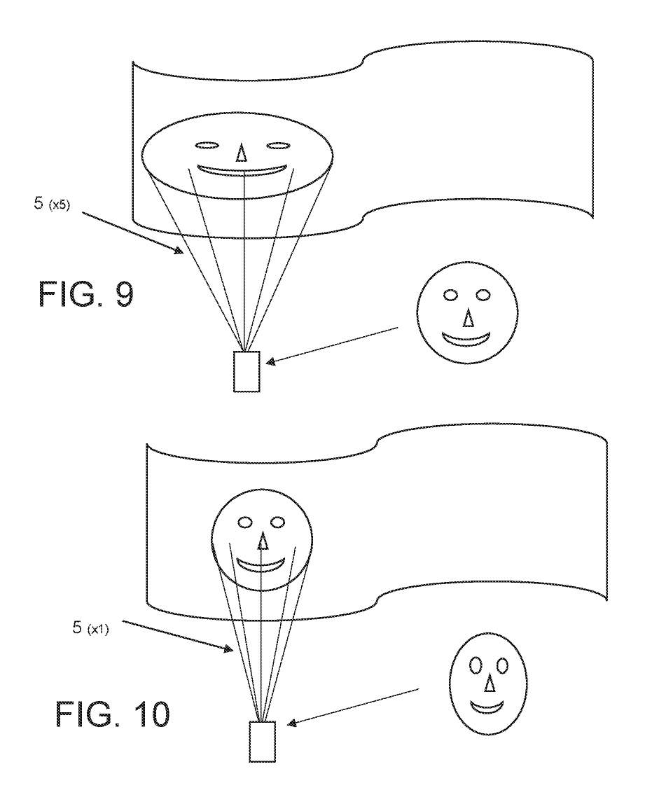

FIG. 9 illustrates a diagram of an exemplary projection device which is projecting a non-corrected image onto a curved surface according to an embodiment. It is noted that potential distortion may occur when a circular face is projected onto a curved surface. Note that the beams from the projection device (5) are roughly equally spaced in angle from the projector.

FIG. 10 illustrates a diagram of an exemplary projection device which is projecting a corrected image onto a curved surface according to an embodiment. FIG. 10 depicts a similar situation as portrayed in FIG. 9, however the image has been altered to account for the surface curvature. This might be accomplished in different ways. One way might be to compress the image very little in the middle, but more toward the edges by pre-processing the image, and/or another might be by projecting the image by altering the direction at which some of the projection beams are projected. These alterations are symbolized by the compressed face that is projected, or by noting that the orientation of the projection beams (5) have changed to compress the projected image.

The process of adjusting images is similar to that of projecting scaled measurement markings in that the information about the surface is used to determine what adjustments need to be made to the image and/or its projection for it to be scaled properly. In an embodiment, one approach is to use a mapping which is a mathematical map that describes how each pixel needs to be adjusted to account for the distortion. It is noted that a similar process is utilized in some software packages that allow one to alter images, such as making them appear curved and/or wrapping an image around a sphere or other object.

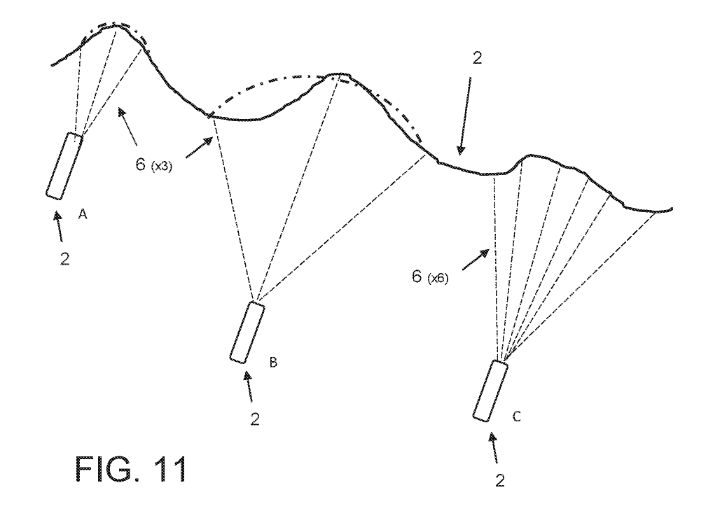

FIG. 11 illustrates a diagram of an exemplary distance marking device and/or projection device in which the distance measurement beams are being utilized to measure distances to the surface according to an embodiment. FIG. 11 illustrates in A how the non-contact method to project scale and/or near scale images could be used appropriately to measure the surface curvature of a complex surface. B illustrates how the method could be used inappropriately, by attempting to measure the curvature of a complex curve using a device that is only capable of measuring the surface curvature of simple curves. C illustrates that if the user desires to measure the surface contour of a more complex surface as in B, additional distance measurements may need to be obtained in order to accomplish this task.

Throughout this disclosure, mentions have been made of creating numerical, mathematical, and/or angle projection representations of the surface, and that these representations can be utilized to change the method of projection and/or alter the projected image. Current laser, coherent light, and/or other projectors as well as software oriented image alteration products exist that are capable of adjusting projection parameters and/or utilizing distortion masks to alter images. In an embodiment, these and other products as now known or may be later derived may use and/or work with methods and/or apparatuses described herein.

Distance measurements utilized in embodiments as disclosed herein can be obtained in a variety of ways, including sonic, optical, mechanical, and/or by utilizing laser and/or other collimated light distance measuring technologies. In an embodiment, laser may be a preferable method due to its accuracy and ability to illuminate its target points. Additionally, in embodiments, one or more of the laser distance measuring elements may serve to create one or more distance measurement marks on the surface.

In addition to single beam distance measuring devices, in an embodiment, measurements might also be obtained using laser scanning distance measuring technologies. Utilizing these technologies increases the resolution of the mappings of the surface by providing many more measurements to the surface, which would be beneficial for complex curved and/or irregular surfaces. The use of laser scanning technologies might also warrant straight line approximations for curved surfaces, in that a detailed mapping of the surface would serve to create a mesh much like that used in computational fluid technologies, where straight line approximations and such fine resolution would provide acceptable results for correcting projected images.

In addition to creating distance measurement markings by utilizing individual laser and/or coherent light markings, in an embodiment, another method to create markings on the surface might involve projecting an image onto a surface that is scaled and contains designations of distance measurements. In an embodiment, another method would be for a processing system to alter the image pixels to create distance measurement images which might include colorful designs and/or animated characters that designate measurements by footprints and/or by other means.

In an embodiment, another method to portray distance measurements on the surface is by utilizing individual projection sources and/or projection sources that utilize a mechanical, computational, optical, electronic, and/or other method to either alter the direction of markings, and/or by blanking the projection beams when not on target.

In addition to the non-contact method of projection, a distance marking device is disclosed. Various embodiments of such a device might be realized, wherein the device might be a handheld device with distance measuring elements located at or near the projection device, thereby allowing a user to point and shoot to display distance measurements on difficult to access locations and/or to display distance measurements in a convenient manner. Additionally, the components may be separated where in one component projects the images while another obtains distance measurements. A processing system might be provided in whole or in part with the projection device, where in existing computer, mobile hardware, and/or other devices with the addition of software might be utilized to serve this process.

In an embodiment, an interface may be provided that allows the user to change settings of the device and/or choose options from various menus on a display. Options might include choosing distances, choosing location from which measurement markings begin, and/or possibly having the option to choose measurement scales that are projected in orthogonal directions.

In an embodiment, measurements may be produced repeatedly, so that as the direction at which the distance marking device is changed, the measurement scale adapts to its new surface location and contour.

Additionally, some embodiments might also include a camera, connections to the interface, and memory storage devices for obtaining measurements of different locations while saving the data and images that show where the data was obtained, thereby greatly simplifying the task of obtaining measurements at off-site locations, and/or to aid in communicating what measurement was obtained.

Additionally, some embodiments might include a fastener so that the distance marking device can be attached to other objects, such as overhead of a table where items are being cut, and/or against the side of a saw so that measurements can be taken while cutting.

In an embodiment, a projection device is also disclosed in which measurements are obtained to determine corrections needed to correct projection distortions caused by surface orientation and/or surface contour. As with the distance marking device, a preferred arrangement of distance measuring elements is near the area from which the images will be projected. A processing system might be provided in whole or in part with the projection device, where in a computer, mobile hardware, and/or other devices with the addition of software might be utilized to serve this process. Projection devices might include laser and/or other coherent light source projection systems. Alterations to images and/or projection direction and/or projection method might be performed by the processing system and/or by other means that utilize existing and/or newly developed software and/or projection processors.

In an embodiment, the projector might also include an interface to provide a means to adjust settings and/or to control inputs and outputs to the projection device. Additionally, distance measurements might be obtained on a continuous basis, thereby allowing the projector to be in motion, and/or to have other objects in motion in front of the projector, wherein the image will continually adapt to new surface orientations and contour.

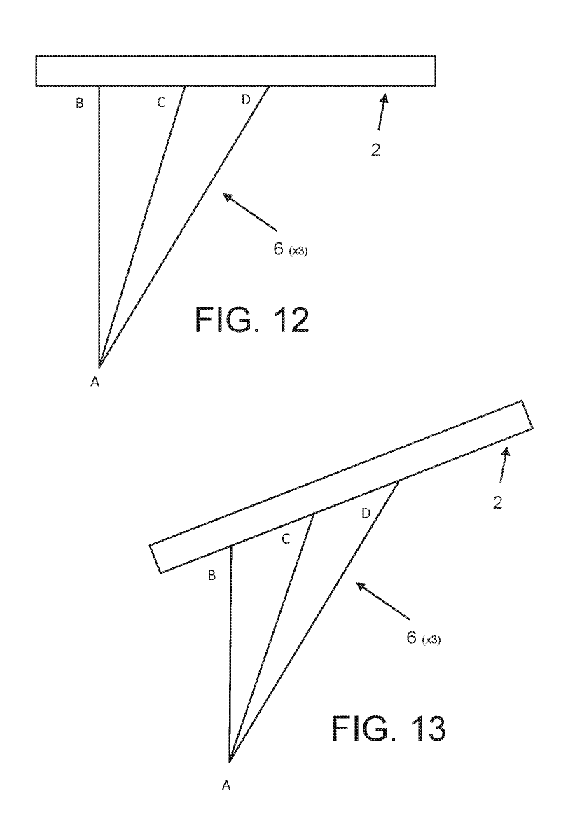

FIG. 12 illustrates a diagram for showing exemplary mathematics for calculating projection angles to a surface that is perpendicular, and not perpendicular (FIG. 13) to where the measurements/projection is made according to an embodiment. FIG. 12 depicts a flat surface (2), and three lines representing distances from an out of surface location, A to points B, C, and D on the flat surface. If the line AB is perpendicular to the flat surface, then determining projection angles from A to point C and/or point D is simplified if the distance AB is known or can be determined by measurement. This measurement can be obtained by physical measurement such as by the use of a tap measure, and/or by a non-contact measurement device such as a laser range finder, coherent light range finder, sonic range finder, optical range finder, and/or other devices and/or by utilizing other information that can mathematically be used to establish distance AB (For example, if distance BC is known, and angle BAC is known, then distance AB can be determined through trigonometry).

In an embodiment, one method to determine the projection angle is to utilize trigonometric equations that relate to right triangles. For example, with AB known to be perpendicular to the surface, and distance AB known, then the projection angle for any desired distance on the surface can be determined by the following trigonometric equation:

$$Projection angle = arc tan ( \frac{desired distance BC along the surface}{distance AB} )$$

The projection angle in this case means that if a projection device was located at A, then the projection angle is the angle BAC, and if a projection device, such as a laser, was pointed at an angle BAC to the right of line AB, then the projected image/mark would strike the surface at point C which is the desired distance BC from point B. The same method could then be utilized to determine the angle needed to project an image/mark at point D. In this manner, multiple distance measurement markings could be projected onto the flat surface utilizing these known angles.

FIG. 13 illustrates a diagram for showing exemplary mathematics for calculating projection angles to a surface that is not perpendicular to where the measurements/projection is made according to an embodiment. FIG. 13 depicts a similar situation as depicted in FIG. 12, however the surface is not perpendicular to the flat surface (2). In this case, at least two distances to the surface may need to be established with a known angle between them, such as distance AB, distance AC, and angle BAC, or at least one distance to the surface with a known surface angle may need to be established, such as distance AB, and angle ABC.

The distance measurements could either be known, measured with contact measurement devices, and/or measured with non-contact distance measurement devices as described above herein. The angles, either BAC and/or ABC might be known and/or measured with angle measuring devices such as protractors and/or utilization of transducers that measure positions and/or angles.

If distance AB and AC are both known, as well as angle BAC, then another method of proceeding is to determine the angle ABC. This can be accomplished by first determining the distance BC. In an embodiment, one method to do this is to utilize the Law of Cosines, which states:

$$Distance BC = \sqrt{{( distance AB )}^{2} + {( distance AC )}^{2} - 2 * AB * AC * cos ( angle BAC )}$$

In an embodiment, another method to determine the distance BC would be to utilize a coordinate system. For example, if the point A is coordinate (0,0), and point B is coordinate (0,distance AB), then the coordinate for C, using the equations of trigonometry, is (distance AC*sin(BAC), distance AC*cos(BAC)). One can then utilize the distance formula to obtain the length of BC:

$$Distance BC = \sqrt{\begin{matrix}{( distance Ac * cos ( angle BAC ) - distance AB )}^{2} + \\ {( distance AC * sin ( angle BAC ) - 0 )}^{2}\end{matrix}}$$

Distance BC can then be utilized to establish the angle ABC via the Law of Sines which states:

$$Angle ABC = arc sin ( distance AC * \frac{sin ( angle BAC )}{distance BC} )$$

With the angle ABC and the distance AB known, the projection angle for any distance along the flat surface from point B can now be determined. For example, if it was desired to project a mark at point D, which is a known distance BD from point B, then distance AD can be established utilizing the Law of Cosines:

$$Distance AD = \sqrt{{( distance AB )}^{2} + {( distance BD )}^{2} - 2 * AB * BD * cos ( angle ABC )}$$

Angle BAD can then be determined by utilizing the Law of Sines:

$$Angle BAD = arc sin ( distance BD * \frac{sin ( angle ABD )}{distance AD} )$$

In an embodiment, an additional method to determine the angle BAD would be to utilize a coordinate system as mentioned above in order to create an equation for a line (the coordinates of two points are required to define a line). This equation could then be used as is and/or parameterized to numerically solve (for example, utilizing Runge-Kutta) for the coordinates that are the desired distance from point B. These coordinates can then be used with the equations of trigonometry to determine the projection angle BAD to project an image/marking at point D.

It is noted that one purpose of obtaining the distance between two measurement points on the surface as described above, is to obtain the angle that one or more of the distance measurement beams is making with the surface. One key element being sought is the angle that one of the beams, most notably the primary beam if one exists, is making with the surface, and not the distance between the two points. Therefore, it may not be necessary to know this distance, as the distance is only being used as an intermediary step to determine the angle.

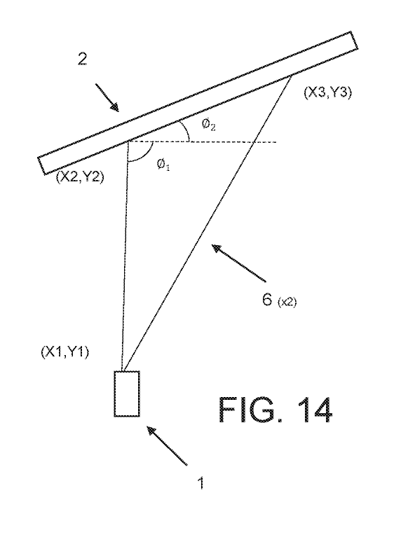

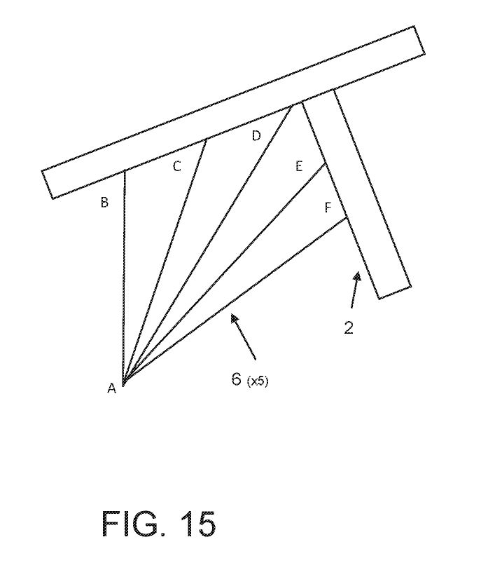

FIG. 14 illustrates a diagram for showing sufficiency of obtaining angles in measurement calculations. One way of obtaining the angle without utilizing the distance is to consider the difference between the slopes of two lines. In the method described above, the coordinate points of all three corners of the triangle made by the two distance measurement beams and the surface may be determined. If a typical Cartesian coordinate frame reference of both points as (X1,Y1) and (X2,Y2) is used, then the slope (m) of one line may be obtained by

$$m = \frac{Y 2 - Y 1}{X 2 - X 1} .$$

The slope of the other line can be established in this same manner. The angle of each line can then be established using equation Ø=arctan(m), where Theta (Ø) is the angle of the line with regard to the line Y=0 (or other suitable horizontal line as depicted in FIG. 14). Once both angles are known, they can be subtracted from each other in order to calculate the angle between them (depending on method of calculation, some adjustment of terms and/or the changing of values from positive to negative may be necessary). In this manner the angle of incidence can be determined without needing to establish the actual distance between the two measurement points.

In an embodiment, any of these methods can then be used alone and/or interchangeably to determine the projection angle of one or more markings that can then be used to project scaled distance measurement markings onto a flat surface. Additionally, it should be noted that the variety of methods presented are not necessarily all inclusive of all the mathematical methods that one might use to calculate the projection angle.

In an embodiment, an alternate method to determine a projection angle is to utilize a scanning distance measurement technique in which a scanning measurement device is used to scan the surface. For example, if the scanning device was a single distance measuring device such as a laser range finder that was mechanically rotated from point B to point D (with reference to FIG. 13) while the angle of measurement was obtained by a transducer, then the distance from point B to the point on the surface at which distance measurement was obtained could be determined using similar processes as described above. In this manner, the angle for each distance measurement can be determined by comparing the angle with its calculated distance from the surface. If the desired distance fell between two distance measurements, then interpolation could be utilized to calculate the actual angle. Other scanning distance measurement devices exist that are non-mechanical that could also be utilized for this purpose wherein the angle might be determined via a calibrated voltage sent to the device to bend its measurement beam and/or by other electronic transducer types.

Calculating projection angles utilizing any of these methods might involve obtaining measurements during projection, and/or obtaining measurements first, and then processing and projecting the distance measurement images.

FIG. 15 illustrates a diagram for showing a method/apparatus that might be used when measurements to more than one flat surface is made according to an embodiment. One advantage of utilizing a scanning technique is that multiple flat surfaces might be scanned, thereby providing a means for distance measurements to be projected onto more than one surface (2). Even if a distance measurement does not locate the corner, as shown with distance measurement D, this corner could still be mathematically calculated by utilizing measurements B, C, and D to determine a line for one wall, and measurements E and F to determine a line for the other wall.

Non-scanning methods could also be utilized as well, however multiple distance measurement devices may need to be utilized to conduct the multiple measurements required to determine the orientation of each surface.

In FIGS. 12, 13, and 15, the projection angle and the distance measurements were all shown to be taken from the out of surface location at point A. Although this is technically feasible for a given embodiment of the method and/or device, in a preferred embodiment, the method and/or device would not need adhere to this particular orientation.

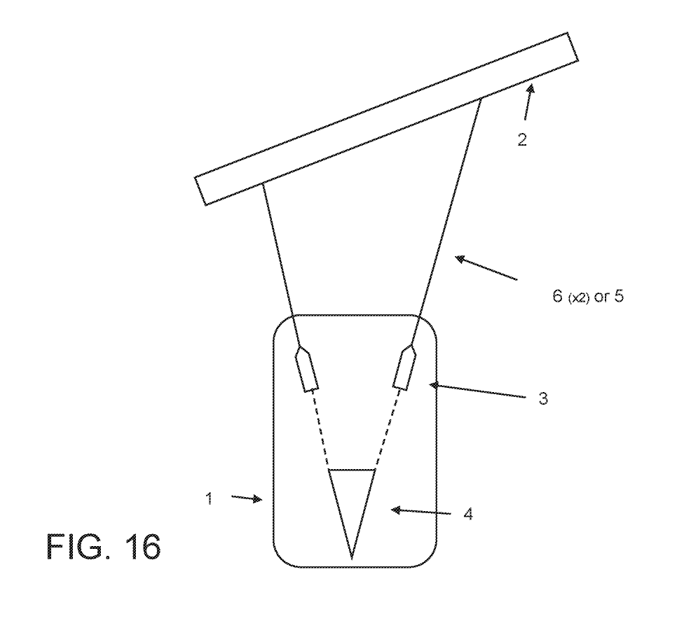

FIG. 16 illustrates a diagram of exemplary projector and distance measurement devices that simplifies the mathematics of determining the angle of projection according to an embodiment. FIG. 16 shows one possible embodiment of the method and/or later discussed device (1) in which the projection from the distance marking projector (4) might occur simultaneously to the measurements being taken by two distance measuring devices such as laser range finders (3). In this particular orientation, the distance measurements are not being taken from the same location as from where the projection occurs. However, due to the angle of the measurement range finders (3), it can be seen that a projection angle can be calculated at the rear of the projector (3) which would simplify the determination of the projection angle. Projection angle could be determined as discussed above, however any distance measurements taken by the distance measuring devices (4) in this embodiment may need to add the distances from the tip of the distance measuring devices to the rear of the projector to be utilized in the formulas. With a known angle between the distance elements, similar mathematics as described above can be utilized to solve for the distance marking projection angles.

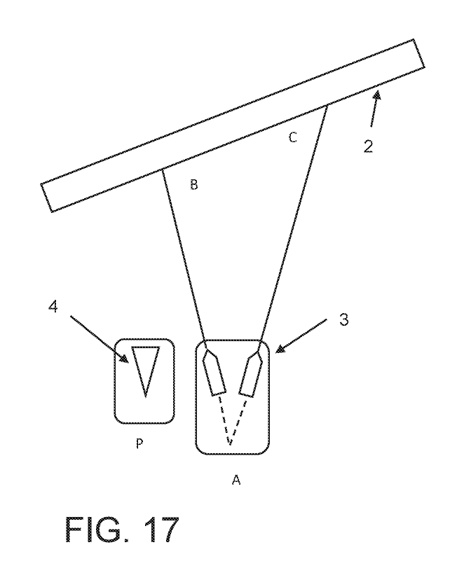

FIG. 17 illustrates a diagram of an exemplary device in which the projection unit is separate from the measurement unit according to an embodiment. It is noted that the distance measurements and projector need not be aligned with each other, or even attached to the same unit. For example, in FIG. 17, the projection device (4) is shown as a separate unit from the measurement device (3). As long as the location of the measurements can be associated to that of the projection device (e.g., mathematically), it is likely a projection angle can be determined. In this case, a coordinate system approach as discussed above may be utilized. If the convergence of the two measurement beams at the rear of the distance measurement device (3) were given the coordinates (A1,A2), then the projection device might be given the coordinates (P1,P2) based on their orientation with respect to A. Once coordinates are determined for point B and point C using methods described earlier, then the projection angle from point P to B, C, or any other point on the flat surface can then be determined.

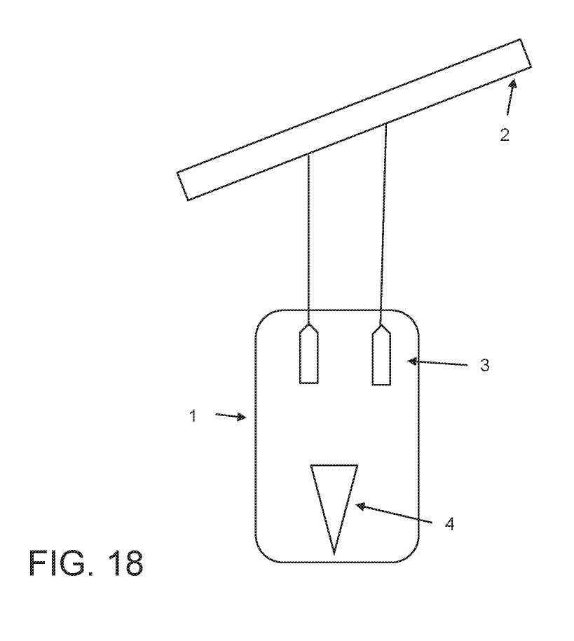

Additionally, distance measurements do not need to be taken in a manner that forms a triangle either. FIG. 18 illustrates a diagram of an exemplary device in which the distance measuring devices are not in a triangular orientation according to an embodiment. Two parallel distance measuring devices (3) can be utilized to measure the flat surface (2). In this case, the distance between the two distance measuring devices may need to be known as well as their orientation to the projection device (4). The two distance measuring devices may be utilized to obtain two distances, and once again a coordinate system could be established to position the distance measuring devices, the points on the surface, and the location from where the projection is made.

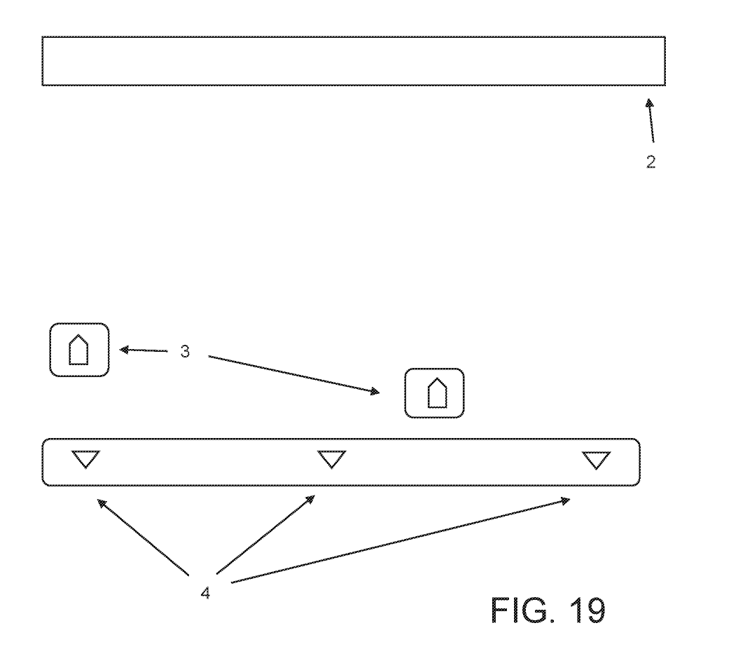

From these examples, it can be appreciated by one skilled in the art that almost any combination of distance measurement device and projection device orientation can be created as long as the orientation of the various components can be related to one another. FIG. 19 illustrates a diagram of an exemplary device in which more than one projection unit is used, and in which the distance measuring devices are separate and not in a particular orientation according to an embodiment. FIG. 19 shows one embodiment where perhaps the flat surface (2) may be too long to be covered by one projection device (4). Therefore three projection devices may be utilized to illuminate the various positions on the surface, and orientation is determined by the use of two distance measuring devices (3) that are placed in the area. As discussed, as long as their orientations are known and/or can be established, and their directions of measurement and/or projections are known and/or can be established, then the distance measurements can be projected to scale onto the flat surface. Locating the individual components might utilize technologies that use radio or wireless signals or other positioning methods to calculate the positions of the individual components.

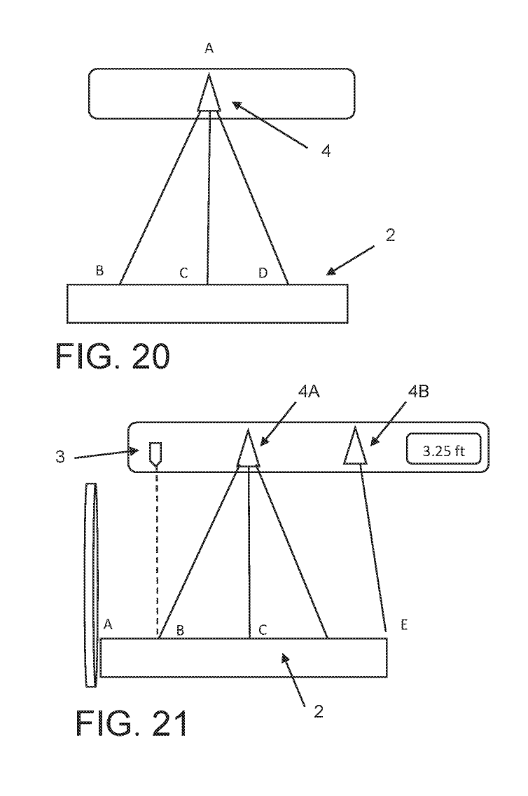

FIG. 20 illustrates a diagram of an exemplary device in which a projection unit, but no distance measuring unit is used according to an embodiment. A measurement device to project distance measurements onto a flat surface may or may not require distance measuring equipment as discussed above. For example, an embodiment of such a device might only utilize a projector to project measurement markings onto a flat surface having been calibrated for a particular distance and/or offering a calibration adjustment to be adjusted for a particular distance as depicted in FIG. 20. In an embodiment, the user of the device may be required to mount or place the projection unit (4) at a certain distance AC from the surface (2). Alternatively, a calibration adjustment control may be utilized by the device to offer flexibility to the user. In this case, the user might mount or place the projection device at a specified location (A), and then use an object of a known distance such as a ruler to place on the surface with one end at C. Utilizing the calibration adjustment, the user can then adjust the projected measurement beams until the projected marking at B coincides with the opposite end of the ruler. In this manner, the measurement distance BC can be known, and other measurement distances such as distance CD can be determined.

FIG. 21 illustrates a diagram of an exemplary device in which the device might be used with a tool such as a table saw according to an embodiment. Other embodiments might contain a single distance measuring device such as depicted in FIG. 21. In an embodiment, a saw is being used to cut wood at A. A single distance measuring device (3) is mounted above the flat surface (2) in which this case the surface might be a piece of wood. A projection device (4A) projects distance markings B, C, and E onto the wood, in which the distance markings take into account the thickness of the wood (as measured by the distance measuring device (3), and the distance AB, an offset needed to avoid interfering with the saw mechanism. In this manner, the user of the saw can mark the wood for the next cut without using a tape measure.

Alternatively as depicted in FIG. 21, a projection device (4B) might project a line onto the wood at a distance specified by the user through an input device. In this case, a measurement of 3.25 feet is displayed. In an embodiment, the system might be mounted on the exit side of the saw so that the user can simply slide the wood until the mark strikes the wood, and then activate the saw.

Other embodiments similar to as depicted in FIG. 1 might contain two distance measuring devices (3) in a hand held unit with an integrated projector (4), display (7), and input interface (9). In this embodiment, a user could utilize this device to project measurements onto a flat surface, and because of its dual distance measuring devices (3), this implementation could likely adapt to angled flat surfaces as well as perpendicular surfaces as shown. The input interface (9) might be a switch and/or button which allows the user to possibly power the unit on/off, to activate ongoing measurements, and/or to choose the increment distance. This device might be capable of obtaining repeated measurements so that the user can move while the device updates the projected distance measurements to maintain scale.

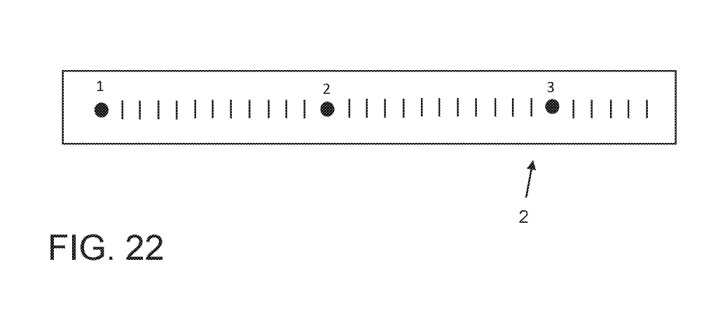

FIG. 22 illustrates a diagram of an exemplary device that projects distance measurements in more than one unit and with additional numeric projections to show quantity according to an embodiment. Additionally, distance markings might have combined units. For instance, an embodiment might show distances in both feet and inches as in FIG. 22. Depending on the type of projector used, measurements might be denoted not only by symbols such as lines and dots, but by numeric values, bars, images, colors, brightness levels, and/or other markings understood by the user to represent distance markings.

Distance markings may or may not incorporate the mark made by the distance measuring devices as well. For example, the zero mark of a particular distance measurement set might include one of the marks left by the distance measuring device used to measure the distance to that particular location.

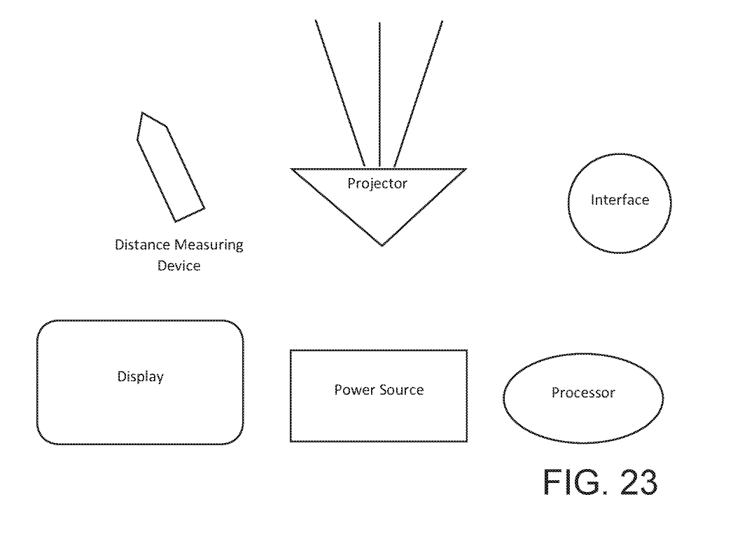

FIG. 23 illustrates a diagram of an exemplary device with various components according to an embodiment. FIG. 23 depicts some of the common components that may be found in certain embodiments of the distance projection device. Some embodiments may contain one or distance measuring devices. The distance measuring device might be comprised of a contact measurement device like a ruler, pole, or mounting device to hold the projector a specified distance from the surface. Other options might include non-contact measurement devices such as optical, sonic, coherent/collimated light, and/or laser range finding devices. These devices might be capable of single measurements, continuous measurements, and/or scanning measurements. As described above, distance measurements may need to have a known orientation to the projector, and/or an offset location that can be calculated or somehow related to that of the projector.

A component of the distance projection device is one or more projectors. Distance measurement markings might be made by a single projector and/or by more than one projector working together. Although coherent light sources might be utilized for this purpose, a concentrated light source such as a laser light source may be preferred. Distance measurement markings might be projected as a single image with one or more incremented distance measurement markings, and/or by individually projected markings. Some projection devices might project all markings simultaneously, and/or might project markings by cycling through the different markings individually.

Some embodiments might include an interface. An interface provides a means of communication between the distance projection device and the user and/or other source. In some embodiments, the interface might serve to control functions of the unit such as power, brightness, measurement on/off/repeat, calibration, measurement units, language, and/or length or angle of projected markings. An interface might also serve to connect to other devices to work in sync. For example, a camera might be attached to the distance projection device that takes photos of what the projection device is pointed at. In this manner, a user might later examine the photographs to see where particular measurements were taken. The interface might be comprised of buttons, sliders, switches, triggers, touchscreens, communication ports, power ports, and/or sensors.

Some embodiments might include a display or other output. A display might consist of lights such as L.E.D.'s, and/or displays capable of depicting graphical images. Output might also include audible and/or tactile devices. Information output/displayed might be comprised of state of the device (power, measurement units, brightness, battery power, etc), information derived from the measurements to the surface (such as distance to surface, angle of surface), and/or information pertaining to related inputs/outputs of the device.

In an embodiment, a power source and/or a connection to a power source may be provided for the operation of the device. This might include a storage power source, such as a battery, a constant power source, such as power from an outlet, and/or a regenerative power source such as a solar panel.

Embodiments of the device may include a single or multiple processors. The processor may be comprised of software and electronic/computational hardware that is specific to the device, and/or might be realized in whole or in part by software used with other existing programmable computational devices such as ‘smart’ phones, computer tablets, laptops, etc. The processor might be responsible in whole or in part of directing the various components to perform their functions when indicated, to calculate the necessary projection angles from supplied data, and controlling inputs, outputs, states of the device, and/or any other functions related to the device directly or indirectly.

The components shown in FIG. 23 may be contained within a single support or case designed for handheld use, or might be separated into several separated components as described earlier. The cases or supports for one or more of the components might contain fasteners to attach the components to various surfaces, and/or adapters to attach the device to common support structures such as a tripod. Additionally, the components might also be molded into structures of other tools or devices, such as the table saw described earlier. Separated structures might communicate with each other via direct wiring, and/or might be connected using wireless technologies.

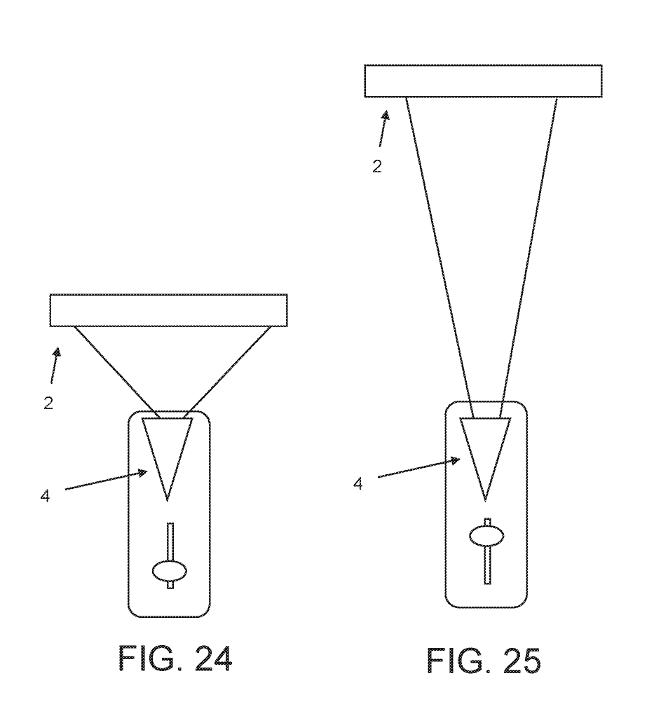

FIG. 24 illustrates a diagram of an exemplary device that can adjust its projection width in a wide angle mode according to an embodiment. FIG. 25 illustrates a diagram of an exemplary device that can adjust its projection width in a narrow angle mode according to an embodiment. FIG. 24 shows an embodiment of the distance measurement device in which the device is shown close to a surface and then again further away from a surface (FIG. 25). The device is shown with a slider that allows the user to control the width of the projected distance measurements. Some projection devices may be able to accommodate a ‘wide angle’ projection and may also be able to have their field of projection altered to project a narrower field of projection. Others may not be able to accommodate these changes and may require more than one projection source for wide angle views, and fewer for narrower views. Depending on configuration, an embodiment may have a slider device like that shown, or may have other methods to adjust beam width or perhaps turn one or more projectors on and/or off or to accommodate different widths of projection. Additionally, electronic controls might provide a variety of other options for controlling the beam width of the device either manually and/or automatically.

To narrow or widen the width of projection, multiple projection units might be utilized, single projection devices that are capable of wider or narrower angle of projections might be used, and/or wide angle devices might be utilized that are capable of blocking and/or shielding the outer edges of the projection beam.

In some embodiments, a cartridge holding the distance measuring elements and/or projector (and/or possibly only a lens or other component) might be utilized so that the user can change the width, angles, and/or performance of the measurement and/or projection by exchanging cartridges. Such a design might utilize a mechanical attribute of the cartridge and/or an electronic signal to and/or from the cartridge to notify the processor of the new configuration. Other embodiments might also exist wherein the user can move the distance measuring elements to different positions, wherein only certain configurations are allowed. For example, the supports holding the distance measuring elements may snap into and/or otherwise lock into certain positions. In these cases, the user may have to enter the configuration, and/or other mechanical design elements, switches, and/or sensors might be utilized to alert the processor to the proper orientation of the distance measuring elements being utilized by the processor.

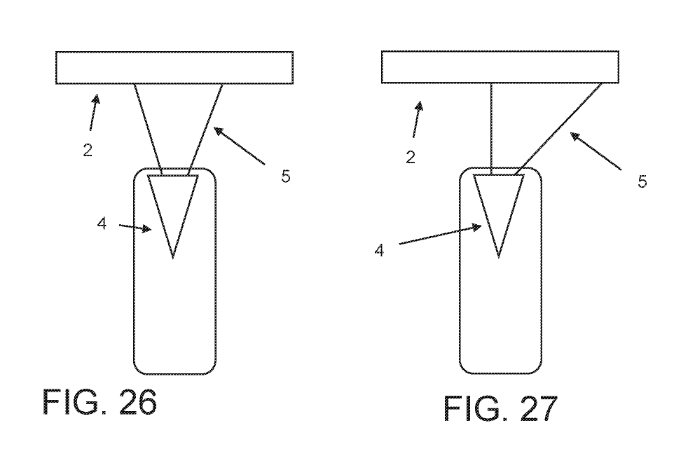

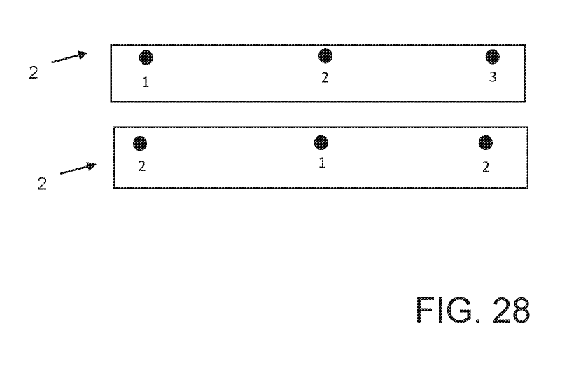

FIG. 26 illustrates a diagram of an exemplary device that can adjust the direction of its projection and/or its start location according to an embodiment. FIG. 27 illustrates a diagram for showing how distance measurement markings may start in different locations according to an embodiment. In addition to controlling the width of the measurement projection, a user may want to control where the measurement projection starts and/or stops. These projection differences may be made with similar methods that are used to control the width of the projection as shown in FIG. 26 and FIG. 27. Additionally as is shown in FIG. 28, the start of the measurements might be made electronically where the measurement values are shown starting from the left, and then shown starting from the center depending on user preference.

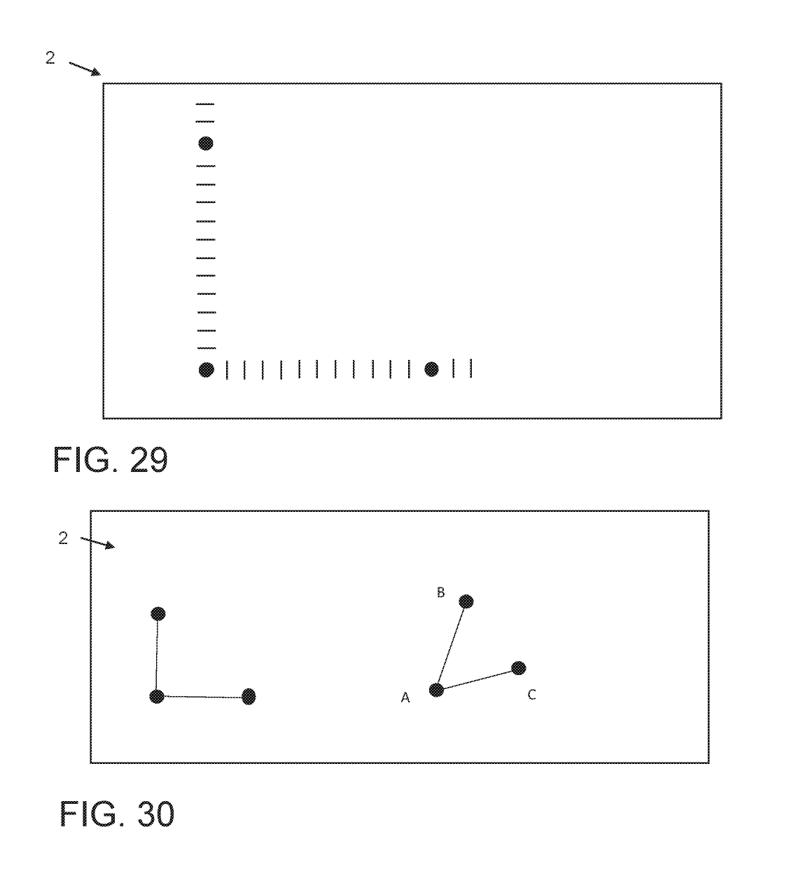

FIG. 29 illustrates a diagram of an exemplary device that projects distance measurement markings in more than one direction according to an embodiment. FIG. 30 illustrates a diagram for showing how projection angle can affect how projected points are skewed according to an embodiment. In addition to dimensions projected in only one direction, dimensions in some embodiments may also be projected in more than one direction as depicted in FIG. 29. At least three measurements that do not lie on the same line may need to be obtained to the surface (if surface orientation was not already known) in order to determine the angle of the surface in relation to the projection source. In order to accomplish this, additional calculations may also need to be conducted as the angle of projection can skew projections as shown in FIG. 30. The left diagram (three dots) of FIG. 30 shows a perpendicular angle projected onto a flat surface from a perpendicular location to the surface. If the same projection is projected up and to the right, the projected angle on the surface will appear more like that shown on the right side.

In an embodiment, this skewing may be corrected by creating a grid system for the points A, B, and C, and using this grid to determine the correct projection direction. In an embodiment, this might require either a projector capable of projecting in different directions, and/or multiple projectors that can be mechanically and/or electronically steered to project at a different direction.

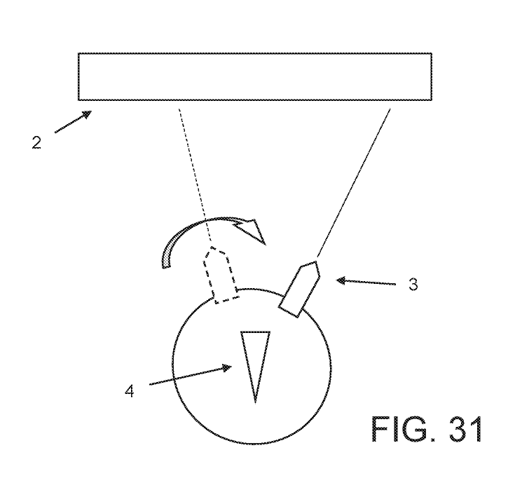

FIG. 31 illustrates a diagram for showing how distance measurement might be taken individually and/or in a scanning manner according to an embodiment. Embodiments have been shown with multiple measurement devices and/or single measurement devices with other known distances. Measurements might also be obtained via mechanical or electronic scanning devices that measure one or more locations instantly and/or systems capable of scanning and obtaining more than one measurement consecutively. Some embodiments might also obtain measurements independently. For example, FIG. 31 shows an embodiment of a measurement device mounted on a tripod. One measurement is obtained, and then the device is rotated to obtain a second measurement. The projector is then used to project measurements onto the surface. This might be performed manually, and/or the device may have a motor that automatically pivots the measurement device to obtain the measurements automatically.

For surfaces that are curved and/or irregular, the process may become more complicated. One approach is to create a representation of the surface, and utilize this representation to determine distances along the surface.

For instance, a surface with curves can be represented and/or approximated by a polynomial. As the order of the polynomial increases, the polynomial can be used to describe curves that are more complex.

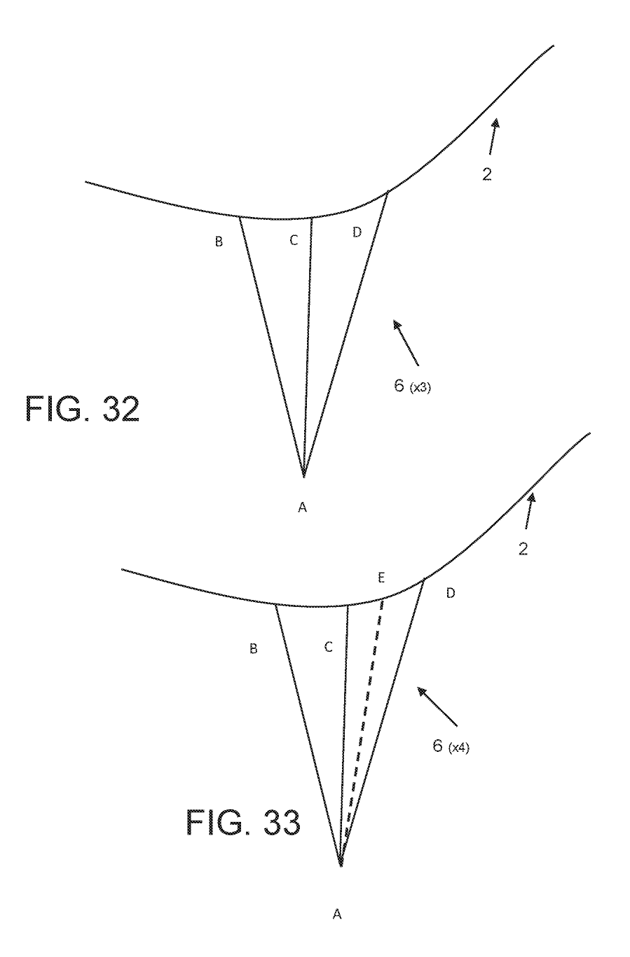

FIG. 32 illustrates a diagram for showing mathematics to calculate projection angles to a curved surface according to an embodiment. FIG. 32 depicts a simple curved surface (2). For this example, we will assume the curve can be approximated with a second order polynomial, which will require three measurements to the surface to ‘solve’. If the curve were more complicated, additional measurements would need to be taken to ‘solve’ the higher level polynomials.

Referring back to FIG. 32, from an off-surface location such as Point A, three measurements are taken to the surface at point B, C, and D. From this point, one could set up a coordinate system, for example, say point A is at coordinate (0,0), and point C is at (distance AC,0). Then B would be at (length AB*−sin(angle CAB), length AB*cos(angle CAB)). D would similarly be at (length AD*sin(angle CAD), length AD*cos(angle CAD)). These coordinates can be calculated using formulas known in the art.

In this manner, the coordinates for point A, C, B, and D have been determined. The equation of a curve that can be described with a second order polynomial is:

y=a₁*x²+a₂*x+a₃

Wherein a1, a2, and a3, are all constants. Therefore the equation for the curve of the curved surface (2) can be computed mathematically by creating three equations (one for each set of (x,y) coordinates), and solving them simultaneously for the three constants.

FIG. 33 illustrates a diagram for showing the mathematics to calculate projection angles to a curved surface according to an embodiment. With the equation of the line known, one can determine the coordinates of a point that is a set distance along the polynomial from a starting point. FIG. 33 depicts a similar image as FIG. 32, except a point “E” has been added. If one wanted to project a mark at E, which is a desired distance along the curve from point C, then one can determine the coordinates of E by first parametrizing (not necessary but simplifies the mathematics) the polynomial. For the polynomial presented, this might look like:

x=t=f(t)

y=a₁*t²+a₂*t+a₃=g(t)

The expressions f(t) and g(t) are utilized to simplify the descriptions below.

The arc length of a curve can be obtained by integrating these equations across the desired length of the curve.

lengthOfCurve=∫ₐ^{b}\sqrt{[f′(t)]²+[g′(t)]²}dt

Wherein f′(t) and g′(t) refer to the derivatives of the functions, and a and b refer to the t values over which we are integrating.

With this equation at hand, one can estimate a coordinate for E and utilize the results to estimate again until one converges on the answer, or can alternatively develop an equation that will produce results directly. This may be accomplished by solving the integration above for t using the symbolic value for the length of the curve. In this manner, one can choose the length, solve for t, and then utilize t to determine the x and y coordinates of E.

While these equations can become complex, the use of modern numerical analysis computer programs can solve these equations quickly and provide the coordinates of point E. Having the coordinates from where the measurements were taken from, the coordinates to where the measurements were taken to, and the coordinates of the desired point a determined distance from a starting point, the coordinate system can be utilized to determine a projection angle from an out of surface location. In this case, having the coordinates of point A, C, and E, one can use the distance formula to calculate the lengths of all three sides of a triangle made by the three points. The Law of Cosines can then be utilized to determine the angle CAE, which if a projector capable of projecting marks at specific angles was at Point A, the angle could be used directly to project a mark at point E. Additional marks at desired points could then be added so that numerous distance markings along the curve could be projected. If the projector was located at a different location, one would simply have to know the coordinates and/or orientation of the projector to again project the distance markings at the proper location.

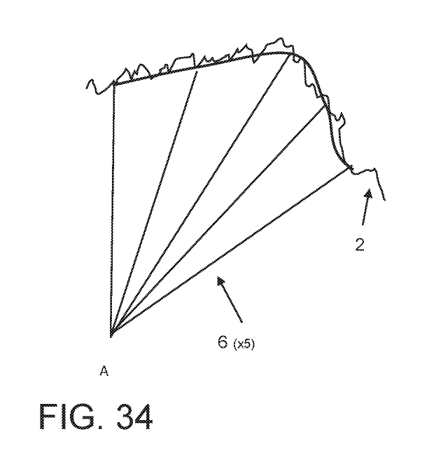

FIG. 34 illustrates a diagram showing how a device might be used for a rough surface according to an embodiment. It should be noted that techniques discussed above can be applied to use different functions, and are not necessarily limited to polynomials. For instance, series solutions and various statistical approximations of curves could also be utilized to calculate mathematical representations of the curved surface. FIG. 34 shows a curved surface (2) which has a rough surface. Perhaps the user might be satisfied with an approximation of surface contour and projected surface distances in which case a lower order curve might be utilized to create a smoother impression of the surface.

For some surfaces, some embodiments might obtain numerous measurements to the surface in similar areas to obtain an average value, which is yet another option that might be useful for measuring rough surfaces.

In an embodiment, other statistical approximations of the distance measurements might also be utilized to include exponential, linear, logarithmic, power, moving average curves and/or others, wherein the optimal choice may be determined by the surface and its properties. Depending on embodiment of the method or distance marking device, the accuracy of the projected measurements to the actual distance measurement values and directions might also be determined and provided to the user as an idea of how accurate the portrayed measurements are. Statistical concepts such as variance or standard deviation might also be represented to help a user understand the accuracy of the measurement marks, and might be preferable in an embodiment that utilizes many measurements to create an approximation to the actual curve.

It should be noted that the equations and concepts disclosed above can work with flat surfaces as well as curved surfaces.

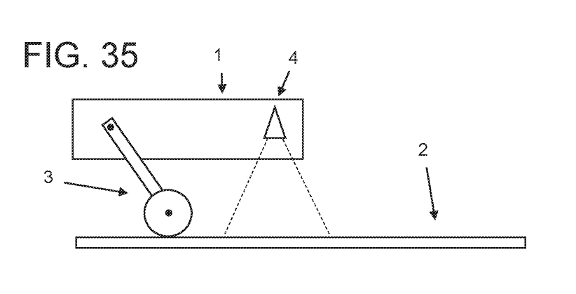

FIG. 35 illustrates a diagram showing an exemplary device that utilizes a contact measurement device according to an embodiment. Obtaining distance measurements might involve utilizing known distances, such as mounting the distance measuring component of the distance marking device a known distance from the surface, and/or utilizing contact measurement devices such as a pole that holds the distance measuring component a particular distance from the surface. FIG. 35 depicts one possible embodiment using a contact distance measurement device (3) wherein a wheel mounted on an arm of the distance marking device (1) is used to determine the distance to the surface (2). The projector (4) can then alter its distance measurement markings to account for the distance to the surface. Others might utilize a combination of known distances, contact, and/or non-contact methods.

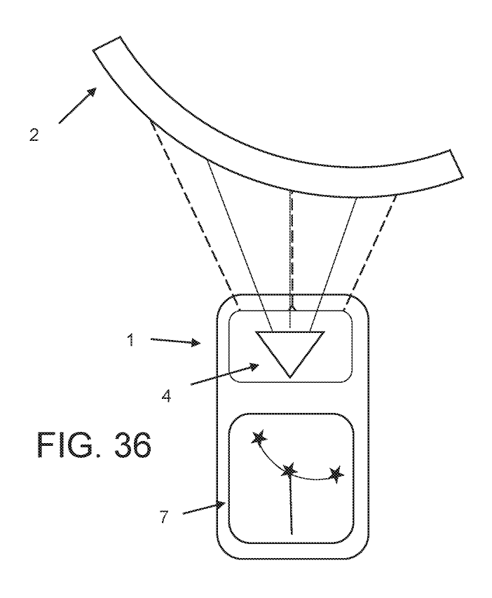

FIG. 36 illustrates a diagram showing an exemplary device utilizing a display and non-contact distance measuring devices according to an embodiment. FIG. 36. depicts one embodiment of the distance marking device (1) that utilizes three distance measuring elements (elements not shown but their distance marks are depicted as dotted lines, where in the elements are presumably located under the projector (4)) to measure the distance to a curved surface (2). Atop the distance measuring elements is a projector denoted as a triangle (4) that is projecting three distance measurement markings to the surface. This distance marking device contains a display (7) that is showing roughly what the curve looks like, and might also display data such as the units of the projected measurements, the distance from the surface, perhaps the angle of curvature of the surface, and possibly even the equation of the surface.

For some embodiments, the user might be offered a menu or choice through an interface which would allow the user to choose one of the mathematical methods stated earlier, and/or to choose the order of the polynomial. Other embodiments might be designed to automatically choose a method for the user.

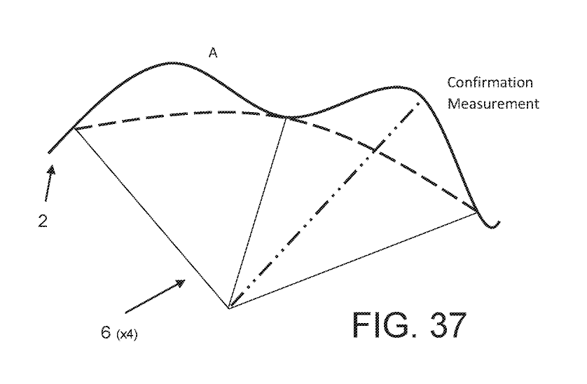

FIG. 37 illustrates a diagram showing how a potential mistake that might occur, and one possible solution to avoid this pitfall according to an embodiment. Other embodiments might utilize a ‘confirmation’ distance measurement as well to assure that errors such as shown in FIG. 37 don't occur. In this example, the user obtained three measurements to the surface (2), however the calculated curve (shown as a dotted line) was not correct for the actual surface. If one or more confirmation distance measurement(s) had been obtained at a different location(s), possibly in between two of the other distance measurements, then the distance marking device might have been able to determine that the calculated curve was incorrect, and might have alerted the user of the problem. Additionally, a graphical display might also be presented, as in FIG. 36 that would allow a user to see the predicted curve, and compare it to the actual surface to see if such an error occurred.

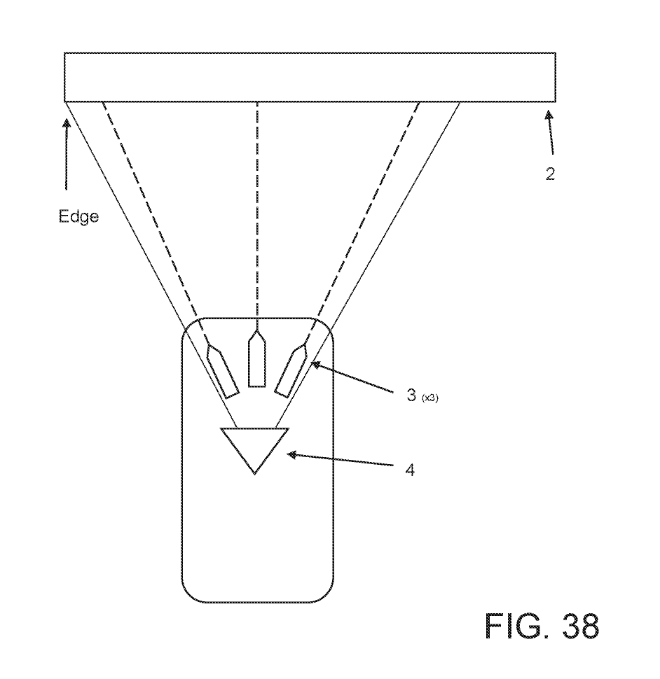

FIG. 38 illustrates a diagram showing an exemplary device suitable for use near edges of surfaces according to an embodiment. It should be noted that for versions of the distance marking device utilized for either flat or curved surfaces, that the angle of projection of the distance measuring elements and/or the projection of the distance measuring markings may change from embodiment to embodiment, or even within a single embodiment. For instance, as FIG. 38 illustrates, one may prefer the distance measuring elements (3) to be within the confines of the projected distance measurement markings (projected by the projector (4)). In this manner, one may be able to project distance measurement markings all the way to the edge of the surface without having to worry that one of the distance measurement beams ‘slips’ off the edge and is no longer functional. In other cases, one may want the distance measurement beam to start at other locations, such as the exact location of the distance measurement marks so that the exact contour of the surface is captured. Both distance measurement beams and projected marks may also be adjustable depending on embodiment to provide the user with flexibility of being able to zoom obtained measurements and/or projected markings.

Besides displaying incremental marks along the surface, some embodiments might also display incremental length markings that are summed at regular intervals much like a tape measure, so that one does not have to count each distance measurement marking (as shown in FIG. 20) Some embodiments may also provide a control so that a desired range can be chosen wherein the range is marked so as to make the end points of the range apparent to the user, with either the display or the actual projection providing the distance results of the desired range.

As with distance marking device used for flat surfaces, distance marking device used for other surfaces may project markings that are in various units of measurements and/or mixed units of measurements, as depicted in FIG. 22 (such as in feet and inches). Some might be calibrated for different tasks, such as projecting marks at 16 inch intervals to project marks to denote where studs on a wall should be placed. Others might project only a single mark at a distance determined by the user, while others may have various patterns pre-programmed or chosen by the user for custom applications.

Some embodiments might obtain measurements repeatedly so that the distance marking device can be pointed at different surfaces and/or different areas of the same surface while maintaining desired scale. This might be useful for a user who is moving about and/or taking rapid measurements at different locations. Other embodiments might only obtain a set of measurements when commanded to do so perhaps by pressing a trigger or button, or may obtain measurements repeatedly while the button or trigger is held, and then stop once the proper desired orientation is obtained and the button or trigger is released. Such an embodiment might be handheld, or possibly designed to be mounted to a support such as a tripod to keep the measurements in place.

Some embodiments might be marketed and/or designed for flat surfaces, however may nevertheless have the potential to also measure or project measurements on curved surfaces. This might be useful for a user who is using the distance marking device on what they believe to be as a flat surface, however the surface may contain some curvature, thereby allowing the distance marking device to warn the user of the surface condition and/or display predicted error.

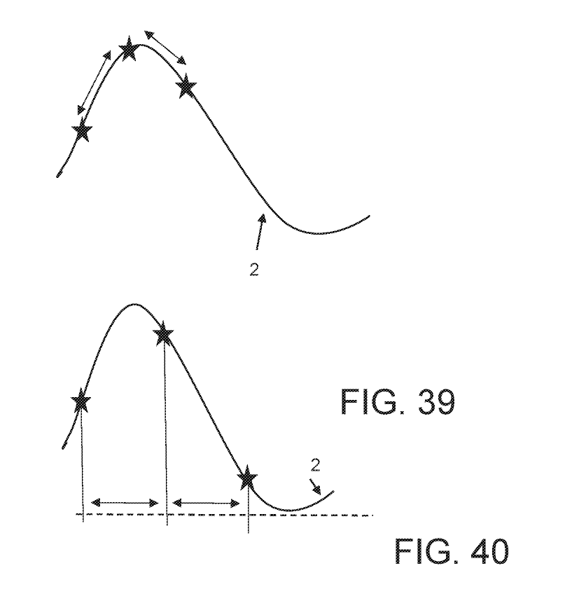

FIG. 39 and FIG. 40 illustrate diagrams showing how two different measurements might be portrayed, distance along the curve, and distance along an axis according to an embodiment. Some embodiments for curved or irregular surface applications may have an option to choose between measurements that measure along the length of the surface, or can transition to a straight line mode that projects distance measurements along a given axis as depicted in FIG. 39. FIG. 38 shows distance measurements (depicted as stars) being projected along the curve, wherein distance measurement increments equate to the length of the curve between points. FIG. 39 shows distance measurements that are spaced by length along a horizontal dotted line.

Additionally, some embodiments might be contained within a single unit, while others might be split into different pieces, such as a distance measuring component and a projection component. Some embodiments may be encased to allow the distance marking device to function in different environments, such as underwater, in toxic environments, and/or even in space.

Additionally, some embodiments might have special attachments and/or fasteners to allow the distance marking device to be attached to different surfaces. For example, the distance marking device might have a fastener and/or be incorporated into a baseball cap and/or hardhat to make it possible for a construction worker to utilize the distance marking device ‘hands-free’. An industrial version of the distance marking device might be utilized at the end of heavy machinery so that the machinery operator can properly determine where to grab an object, create a hole to a specified depth, or perform other duty. The distance marking device might be created in a miniature versions for uses such as metrology and/or operations requiring small measurement scales. These are only a few of the many possible orientations and/or methods of attachment, and are not meant to be all inclusive of the number of possible orientations, uses, and/or to describe the various methods of attachment.

Embodiments utilized for flat, curved, or other surfaces each may require some type of projector to project the distance markings onto the surface. A projector used in this context might consist of one or more independent and/or combined light sources and/or lasers that are mechanically, optically, and/or electronically steered or controlled in whole or in part to point the light or laser at particular location(s) (Note: “electronically” and/or “mechanically” in this context is meant to be broadly encompassing, such as electronically would include such things as circuitry that might be used in a controller, generation of a pulse to cause illumination at a certain instant or angle, electronic pulses designed to cause photons to be discharged, and/or circuitry to generate a sound wave at a particular wavelength, and mechanical would include such concepts and items as motors, mirrors, and/or even vibrations that can be generated at particular frequencies in a crystal or other substrate; similarly, “controlled” is meant to include concepts such as not only directing the illumination of a projector in a particular direction, but also concepts such as blocking all or a portion of the illuminating source, turning it on or off, and/or adjusting the brightness, color, or other attribute of the illuminating source at desired intervals to change the appearance, shape, or other attribute of the projected image).

In embodiments, a projector might also consist of a projection system that uses optics, lasers, LED's, or one of a host of other display technologies that can be used to generate and/or project light in either the visible or non-visible spectrum. These types of projectors might be capable of projecting a single image that contains numerous distance measurement markings, and/or might be comprised of one or more independent projection devices that each project only a portion of the total projected image. These projections might be comprised of coherent light, lasers, and/or electromagnetic radiation in either the visible and/or non-visible spectrum. Some embodiments might also project markings other than light, for instance one might spray paint and/or may cast projectiles at the surface to create permanent markings on the surface.

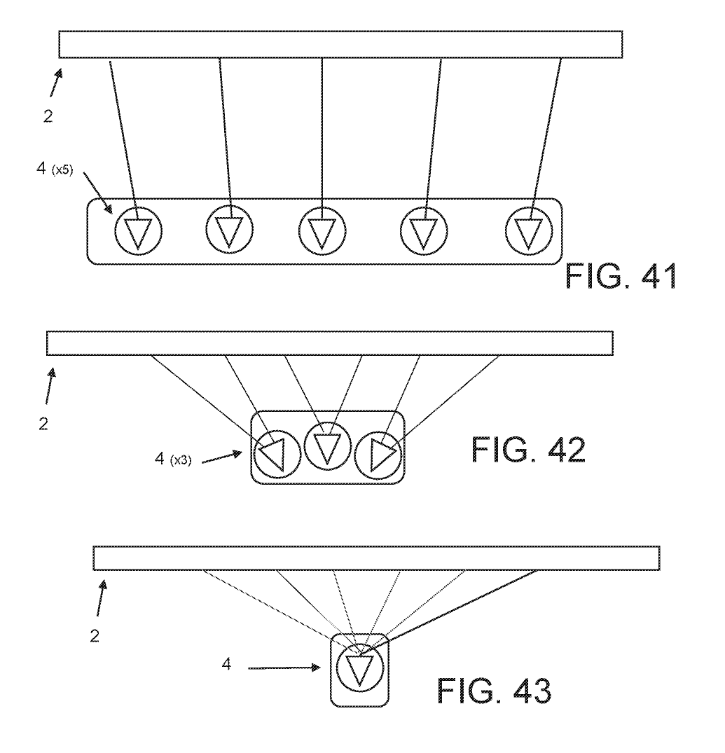

FIG. 41, FIG. 42, and FIG. 43 illustrate diagrams showing several potential exemplary methods of projecting individual measurement marks (not all inclusive) according to an embodiment. FIG. 41 shows five distinct projection devices (4) that each display only one measurement mark. These projection devices might consist of individual laser illumination sources that may be electronically steered, or even steered using mechanical means such as a motor that turns a turret on which the laser is mounted. FIG. 42 shows three separate projection devices (3) that each are capable of projecting more than one distance measurement mark. In this case, each projector is responsible for displaying distance measurement marks on only a certain portion of the surface, and are calibrated to work together. FIG. 43 shows a single distance projection device (3). This embodiment might be capable of displaying all the distant measurement marks at the same time, or might quickly alternate between all the distance measurement mark positions individually but fast enough so that the user is able to observe all the various positions.

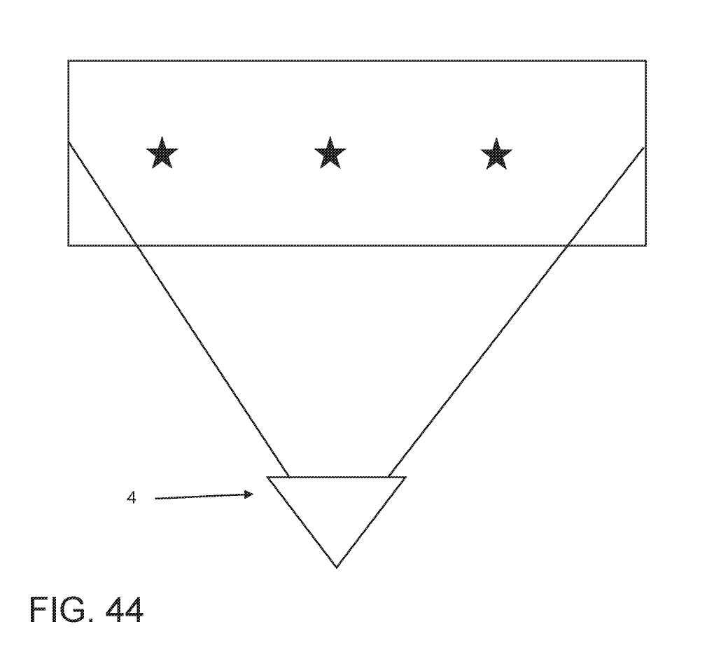

FIG. 44 illustrates a diagram showing another potential exemplary method of projection wherein a single image is projected according to an embodiment. The projector (4) is projecting a single image on which calibrated markings have been ordered. Existing laser and coherent light projectors might be capable of projecting such an image, wherein the projected image is either a standard image for a given distance, and/or calibrated by a processor to fit the given surface shape and orientation with respect to the projector.

Devices described in FIG. 41 through FIG. 44 are not an exhaustive list of the many possible methods of projection, they are only provided to give some examples of different methods that might be utilized to project distance measurement markings.

In an embodiment, distance measurement markings might refer to a dot that marks a point on the surface, a bar, a line, an alphanumeric character or string, and/or any type of visual or graphical depiction made by laser and/or light that can be interpreted into distance measurement markings. The markings may also include physical markings such as a hole, an imprint, paint, and/or other substances applied to the surface. Distance markings may or may not incorporate the mark made by the distance measuring component of the distance marking device as well. For example, the zero mark of a particular distance measurement set might include one of the marks left by the distance measuring device used to measure the distance to that particular location, while others might be created by non-distance measuring elements (e.g., projection only elements).

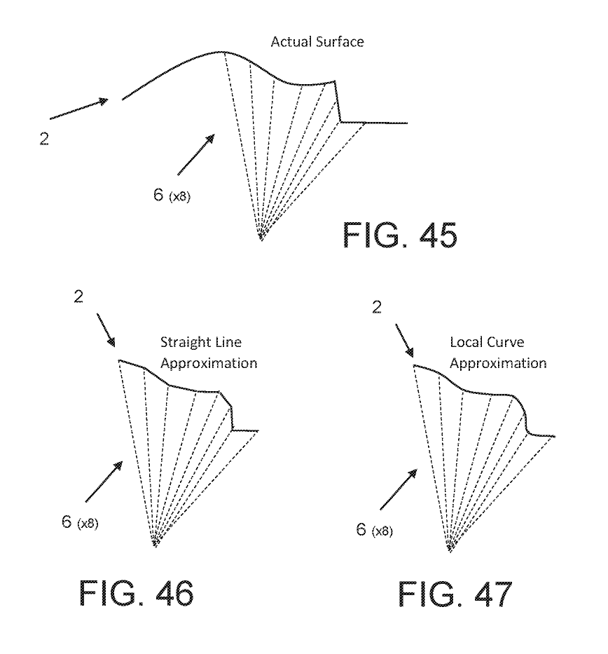

FIG. 45 illustrates a diagram of an exemplary device to measure irregular surfaces by utilizing a scanning technique according to an embodiment. FIG. 46 illustrates a diagram of an exemplary device to measure irregular surfaces by utilizing a scanning technique with a straight line estimation according to an embodiment. FIG. 47 illustrates a diagram of an exemplary device to measure irregular surfaces by utilizing a scanning technique with a local curve estimation according to an embodiment. Some surfaces might not be conducive to being described (e.g., by a mathematical representation), however it might still be desired to project distance measurements along the surface. One method to handle such a case would be to scan the surface with a non-contact distance measuring device such as a laser distance measuring device or one of the other non-contact distance measuring technologies discussed above. Depending on the resolution of the scan, the individual distance measurement points might be considered as independent discrete points connected by straight lines, and/or might be statistically connected using local approximations of curves that are connected across the surface to create a piecewise continuous and/or discontinuous surface. Utilizing a coordinate grid approach as mentioned earlier, the direction of projection can then be determined from the combination of these ‘parts’.

Calculating projection angles utilizing any of these methods might involve obtaining measurements during projection, and/or obtaining measurements first, and then processing and projecting the distance measurement projection(s), and/or any other combination of measurement, calculation, and projection.

With the ability to create scaled measurements on a variety of different surfaces, the methods described can be translated in a similar manner to the projection of images as discussed above. One might choose to project a grid onto a surface that is scaled to a certain size such as square meters to make laying out a project easier. One might choose to have a system that projects scaled size images of windows, doors, cabinets, and refrigerators to make planning a room easier. Perhaps a mall might project images of additional human sized shoppers walking along side of existing shoppers to create the appearance of more people in the mall, or project moving advertisements in front of patrons. Or the concepts could be used to simply make an existing projector easier to set up by automatically “tuning” itself for the distance and angle of the surface on which it will project.

The present invention should not be considered limited to the embodiments described above, but rather should be understood to cover all aspects of the invention as fairly set out in the attached claims. Various modification as well as numerous structures to which the present invention may be applicable, will be readily apparent to those skilled in the art to which the present invention is directed upon review of the present disclosure. The claims are intended to cover such modifications.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

Also, while description of flows have been discussed and/or illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as a discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

As the foregoing discussion has been presented for purposes of illustration and description, the foregoing is not intended to limit the disclosure to the form or forms disclosed herein. In the foregoing description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The headings, titles, or other descriptions of sections contained in this disclosure have been inserted for readability and convenience of the reader and are mainly for reference only and are not intended to limit the scopes of embodiments of the invention.

What is claimed is:

1. An apparatus for projecting an image to a surface, comprising:
computational equipment, including a processor, configured to determine one or more portions of an altered image, the altered image being a representation of the image, and each of the portions of the altered image for projection on a corresponding portion of the surface, wherein each of the portions of the altered image is based on a respective portion of the image and a distance to the corresponding portion of the surface and an orientation the corresponding portion of the surface; and
one or more projectors, each of the projectors configured to project one or more projections, each of the projections projecting at least one of the portions of the altered image to the corresponding portion of the surface, wherein
a combination of the projections of the projectors on the surface comprises at least a substantially accurate representation of the image.

2. The apparatus of claim 1, wherein the distance is provided by a distance measurer.

3. The apparatus of claim 1, wherein
the altered image comprises at least a first portion of the altered image and a second portion of the altered image, wherein the first portion of the altered image corresponds to a first corresponding portion of the surface and the second portion of the altered image corresponds to a second corresponding portion of the surface, wherein
the first corresponding portion of the surface is different from the second corresponding portion of the surface in at least one point, and wherein
the first portion of the altered image and the second portion of the altered image are determined based on a first distance to the first corresponding portion of the surface and a second distance to the second corresponding portion of the surface and a first orientation of the first corresponding portion of the surface and a second orientation of the second corresponding portion of the surface.

4. The apparatus of claim 1, wherein the altered image is a scaled representation of the image.

5. The apparatus of claim 1, wherein the altered image is determined using a distortion mask technique.

6. The apparatus of claim 1, wherein the altered image is determined based on an approximation of a contour of at least a portion of the surface, and wherein the approximation is based on two or more points on the surface and respective distances to the two or more points.

7. The apparatus of claim 1, wherein the image comprises measurement markers, and wherein the combination of the projections comprises a substantially accurate representation of the measurement markers on the surface for measurement of the surface.

8. The apparatus of claim 1, wherein the apparatus is configured for automatic repeated operation based on an update to the distance.

9. The apparatus of claim 1, wherein the altered image is determined by not including portions of the altered image that correspond to respective substantially disjointed portions of the surface.

10. The apparatus of claim 1, wherein the surface is a user-definable portion of a larger surface.

11. A method for projecting an image to a surface, comprising:
receiving one or more distances, each of the distances to a corresponding portion of the surface;
determining one or more portions of an altered image, each of the portions of the altered image based on a respective portion of the image and one of the distance to a corresponding one portion of the surface and an orientation the corresponding portion of the surface, the altered image being a representation of the image, and each of the portions of the altered image for projection on a corresponding portion of the surface; and
projecting one or more projections to one or more corresponding portions of the surface, each of the projections having at least one of the portions of the altered image to the corresponding portion of the surface, wherein
a combination of the projections on the surface comprises at least a substantially accurate representation of the image.

12. The method of claim 11, wherein
the determining comprises determining at least a first portion of the altered image and a second portion of the altered image based on a first distance to a first corresponding portion of the surface and a second distance to a second corresponding portion of the surface and a first orientation of the first corresponding portion of the surface and a second orientation to a second corresponding portion of the surface, wherein
the altered image comprises at least the first portion of the altered image and the second portion of the altered image, wherein the first portion of the altered image corresponds to a first corresponding portion of the surface and the second portion of the altered image corresponds to a second corresponding portion of the surface, and wherein
the first corresponding portion of the surface is different from the second corresponding portion of the surface in at least one point.

13. The method of claim 11, wherein the altered image is a scaled representation of the image.

14. The method of claim 11, wherein the determining comprises determining the altered image using a distortion mask technique.

15. The method of claim 11, wherein the determining comprises determining the altered image based on an approximation of a contour of at least a portion of the surface, and wherein the approximation is based on two or more points on the surface and respective distances to the two or more points.

16. The method of claim 11, wherein the image comprises measurement markers, and wherein the combination of the projections comprises a substantially accurate representation of the measurement markers on the surface for measurement of the surface.

17. The method of claim 11, further comprising automatically repeating the method.

18. The method of claim 1, wherein the determining comprises determining the altered image by not including portions of the altered image that correspond to respective substantially disjointed portions of the surface.

19. The method of claim 1, further comprising receiving a user input for defining the surface from a portion of a larger surface.

20. An apparatus for projecting an image to a surface, comprising:
one or more distance measurer configured to measure one or more distances to one or more respective portions of the surface;
computational equipment, including a processor, configured to determine one or more portions of an altered image, the altered image being a representation of the image, and each of the portions of the altered image for projection on a corresponding portion of the surface, wherein each of the portions of the altered image is based on a respective portion of the image and one of the distances to the one respective portion of the surface related to the corresponding portion of the surface and an orientation of the corresponding portion of the surface; and
one or more projectors, each of the projectors configured to project one or more projections, each of the projections projecting at least one of the portions of the altered image to the corresponding portion of the surface, wherein
a combination of the projections of the projectors on the surface comprises at least a substantially accurate representation of the image, wherein
the altered image comprises at least a first portion of the altered image and a second portion of the altered image, wherein the first portion of the altered image corresponds to a first corresponding portion of the surface and the second portion of the altered image corresponds to a second corresponding portion of the surface, wherein
the first corresponding portion of the surface is different from the second corresponding portion of the surface in at least one point, and wherein
the first portion of the altered image and the second portion of the altered image are determined based on a first distance to the first corresponding portion of the surface and a second distance to the second corresponding portion of the surface and a first orientation of the first corresponding portion of the surface and a second orientation of a second corresponding portion of the surface.
